(19) United States
(12) Patent Application Publication
(10) Pub. No.: US 2026/0264250 A1
(43) Pub. Date: Sep. 10, 2026

(54) ROBOT CONTROL DEVICE, ROBOT CONTROL METHOD, AND ROBOT SYSTEM

(71) Applicant: Sony Group Corporation, Tokyo (JP)

(72) Inventors: Tetsuya NARITA, Tokyo (JP); Yoshikazu FURUYAMA, Kanagawa (JP); Satoko MIZUTANI, Chiba (JP); Kiyokazu MIYAZAWA, Kanagawa (JP); Wataru KOKUBO, Tokyo (JP)

(73) Assignee: Sony Group Corporation, Tokyo (JP)

(21) Appl. No.: 19/163,428

(22) PCT Filed: Nov. 15, 2023
(86) PCT No.: PCT/JP2023/041157

§ 371 Date: Sep. 9, 2025

(30) Foreign Application Priority Data
Mar. 30, 2023 (JP) 2023-054742

(51) Int. Cl. B25J 9/16

(52) U.S. Cl. CPC B25J 9/1694; B25J 9/1669

(57) ABSTRACT

A robot control device of the present disclosure includes a recognition section and a controller. The recognition section recognizes a measurement target on the basis of distance information about the measurement target measured by a distance measurement sensor provided on a robot and tactile information about the measurement target measured by a tactile sensor provided on the robot. The controller performs operation control of the robot on the basis of information about the measurement target recognized by the recognition section.

### CROSS REFERENCE TO RELATED APPLICATIONS

This application claims the benefit of Japanese Priority Patent Application JP 2023-054742 filed on Mar. 30, 2023, the entire contents of each which are incorporated herein by reference.

### TECHNICAL FIELD

The present disclosure relates to a robot control device, a robot control method, and a robot system.

### BACKGROUND ART

There are methods of performing operation control of a robot by measuring a position/orientation of the robot, or a measurement target (such as an object to be grasped) of the robot with various sensors (see PTLs 1 to 3).

### CITATION LIST

### Patent Literature

PTL 1: International Publication No. WO2021/033509
PTL 2: Japanese Unexamined Patent Application Publication No. H11-28692
PTL 3: International Publication No. WO2022/030242

### SUMMARY

### Technical Problem

In order to perform a flexible and stable operation by a robot, it is desirable to improve recognition accuracy of a measurement target such as an object or an environment.

It is desirable to provide a robot control device, a robot control method, and a robot system each of which makes it possible to improve recognition accuracy of an object and an environment, and perform a flexible and stable operation by a robot depending on a situation.

### Solution to Problem

A robot control device according to an embodiment of the present disclosure includes: a recognition section that recognizes a measurement target on the basis of distance information about the measurement target measured by a distance measurement sensor provided on a robot and tactile information about the measurement target measured by a tactile sensor provided on the robot; and a controller that performs operation control of the robot on the basis of information about the measurement target recognized by the recognition section.

A robot control method according to an embodiment of the present disclosure includes: recognizing a measurement target on the basis of distance information about the measurement target measured by a distance measurement sensor provided on a robot and tactile information about the measurement target measured by a tactile sensor provided on the root; and performing operation control of the robot on the basis of information about the recognized measurement target.

A robot system according to an embodiment of the present disclosure includes: a robot provided with a distance measurement sensor and a tactile sensor; and a robot control device that performs control of the robot. The robot control device includes a recognition section that recognizes a measurement target on the basis of distance information about the measurement target measured by the distance measurement sensor provided on the robot and tactile information about the measurement target measured by the tactile sensor provided on the robot, and a controller that performs operation control of the robot on the basis of information about the measurement target recognized by the recognition section.

In the robot control device, the robot control method, and the robot system according to the embodiments of the present disclosure, the measurement target is recognized on the basis of the distance information about the measurement target measured by the distance measurement sensor provided on the robot, and the tactile information about the measurement target measured by the tactile sensor provided on the robot, and operation control of the robot is performed on the basis of information about the recognized measurement target.

### BRIEF DESCRIPTION OF DRAWINGS

FIG. 1 is a configuration diagram illustrating an overview of a robot system according to a comparative example.

FIG. 2 is a configuration diagram illustrating the overview of the robot system according to the comparative example.

FIG. 3 is a configuration diagram schematically illustrating an example of a hardware configuration of a robot system according to an embodiment of the present disclosure.

FIG. 4 is a configuration diagram schematically illustrating an example of the hardware configuration of the robot system according to the embodiment.

FIG. 5 is a configuration diagram schematically illustrating an example of the hardware configuration of the robot system according to the embodiment.

FIG. 6 is a configuration diagram schematically illustrating an example of the hardware configuration of the robot system according to the embodiment.

FIG. 7 is a configuration diagram schematically illustrating an example of the hardware configuration of the robot system according to the embodiment.

FIG. 8 is a configuration diagram schematically illustrating an example of the hardware configuration of the robot system according to the embodiment.

FIG. 9 is a configuration diagram schematically illustrating an example of a sensor arrangement in the robot system according to the embodiment.

FIG. 10 is a configuration diagram schematically illustrating an example of the sensor arrangement in the robot system according to the embodiment.

FIG. 11 is a configuration diagram schematically illustrating an example of the sensor arrangement in the robot system according to the embodiment.

FIG. 12 is a configuration diagram schematically illustrating an example of the sensor arrangement in the robot system according to the embodiment.

FIG. 13 is a configuration diagram schematically illustrating an example of the sensor arrangement in the robot system according to the embodiment.

FIG. 14 is a configuration diagram schematically illustrating an example of the sensor arrangement in the robot system according to the embodiment.

FIG. 15 is an explanatory diagram illustrating an overview of a method of measuring an object by the robot system according to the embodiment.

FIG. 16 is an explanatory diagram illustrating an example of a technique of estimating an object shape by the robot system according to the embodiment.

FIG. 17 is an explanatory diagram schematically illustrating an example of a distance measurement error of a distance measurement sensor in the robot system according to the embodiment.

FIG. 18 is an explanatory diagram schematically illustrating an example of a sensor noise distribution of a distance measurement sensor measurement point and a tactile sensor measurement point in the robot system according to the embodiment.

FIG. 19 is an explanatory diagram schematically illustrating an example of the sensor noise distribution of the distance measurement sensor measurement point and the tactile sensor measurement point in the robot system according to the embodiment.

FIG. 20 is an explanatory diagram schematically illustrating an example of the technique of estimating an object shape by the robot system according to the embodiment.

FIG. 21 is an explanatory diagram schematically illustrating an example of the technique of estimating an object shape by the robot system according to the embodiment.

FIG. 22 is an explanatory diagram schematically illustrating an example of the technique of estimating an object shape by the robot system according to the embodiment.

FIG. 23 is an explanatory diagram schematically illustrating an example of the technique of estimating an object shape by the robot system according to the embodiment.

FIG. 24 is an explanatory diagram schematically illustrating an example 1 of active sensing by the robot system according to the embodiment.

FIG. 25 is an explanatory diagram schematically illustrating the example 1 of active sensing by the robot system according to the embodiment.

FIG. 26 is an explanatory diagram schematically illustrating an example 2 of active sensing by the robot system according to the embodiment.

FIG. 27 is an explanatory diagram schematically illustrating an example 3 of active sensing by the robot system according to the embodiment.

FIG. 28 is an explanatory diagram schematically illustrating the example 3 of active sensing by the robot system according to the embodiment.

FIG. 29 is an explanatory diagram schematically illustrating a first method of narrowing down grasp candidate points in consideration of grasp stability by the robot system according to the embodiment.

FIG. 30 is an explanatory diagram schematically illustrating a second method of narrowing down grasp candidate points in consideration of grasp stability by the robot system according to the embodiment.

FIG. 31 is an explanatory diagram schematically illustrating an example 4 of active sensing by the robot system according to the embodiment.

FIG. 32 is an explanatory diagram schematically illustrating the example 4 of active sensing by the robot system according to the embodiment.

FIG. 33 is an explanatory diagram illustrating an example of an operation of moving a hand close to an object that is a measurement target in the robot system according to the embodiment.

FIG. 34 is an explanatory diagram illustrating an example of a technique of determining a grasping mode with use of an object environment recognition result including uncertainty information in the robot system according to the embodiment.

FIG. 35 is an explanatory diagram illustrating a specific example of a procedure 2 (rule-based) illustrated in FIG. 34.

FIG. 36 is an explanatory diagram illustrating a specific example of the procedure 2 (learning-based) illustrated in FIG. 34.

FIG. 37 is an explanatory diagram illustrating a specific example of a procedure 3 illustrated in FIG. 34.

FIG. 38 is an explanatory diagram illustrating a modification example of the technique of determining a grasping mode with use of an object environment recognition result including uncertainty information in the robot system according to the embodiment.

FIG. 39 is a configuration diagram schematically illustrating an example in which a sensor, other than a distance measurement sensor and a tactile sensor, is provided in the robot system according to the embodiment.

FIG. 40 is a block diagram schematically illustrating a first configuration example of a control block (a robot control device) of the robot system according to the embodiment.

FIG. 41 is a block diagram schematically illustrating a second configuration example of the control block (the robot control device) of the robot system according to the embodiment.

FIG. 42 is a flowchart illustrating a first example of a control operation of the robot system according to the embodiment.

FIG. 43 is a flowchart illustrating a second example of the control operation of the robot system according to the embodiment.

FIG. 44 is a flowchart illustrating a third example of the control operation of the robot system according to the embodiment.

### DESCRIPTION OF EMBODIMENTS

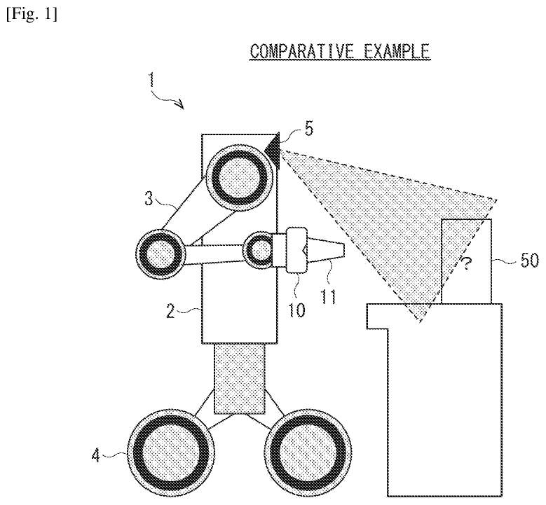

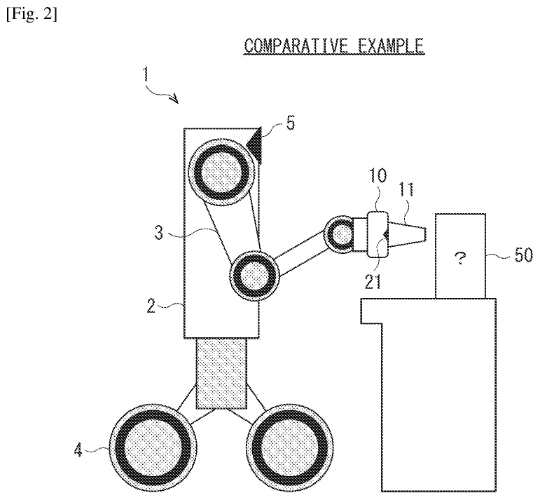

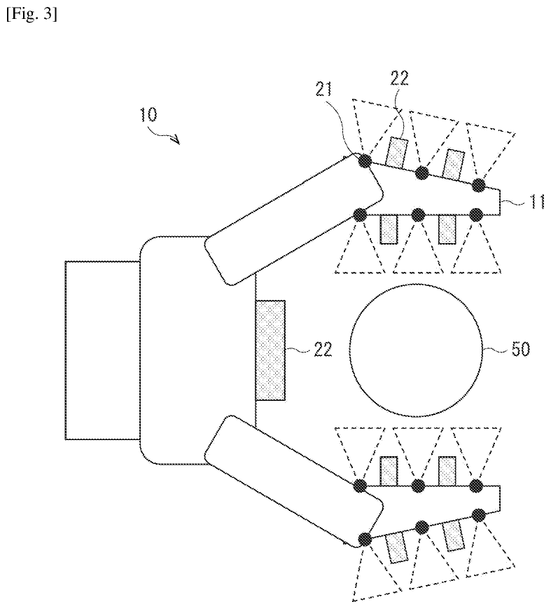

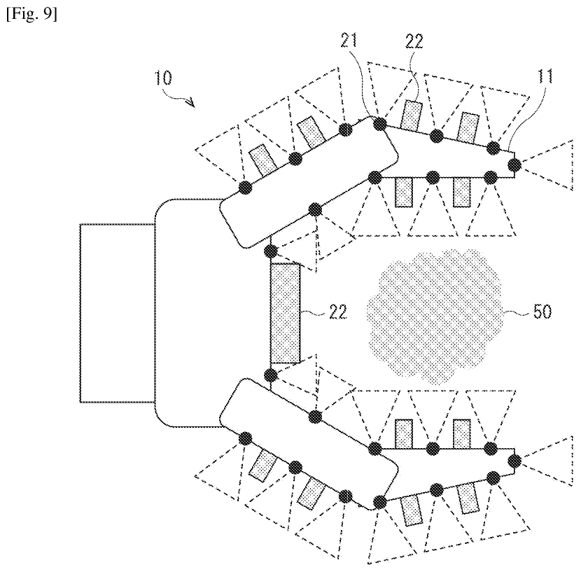

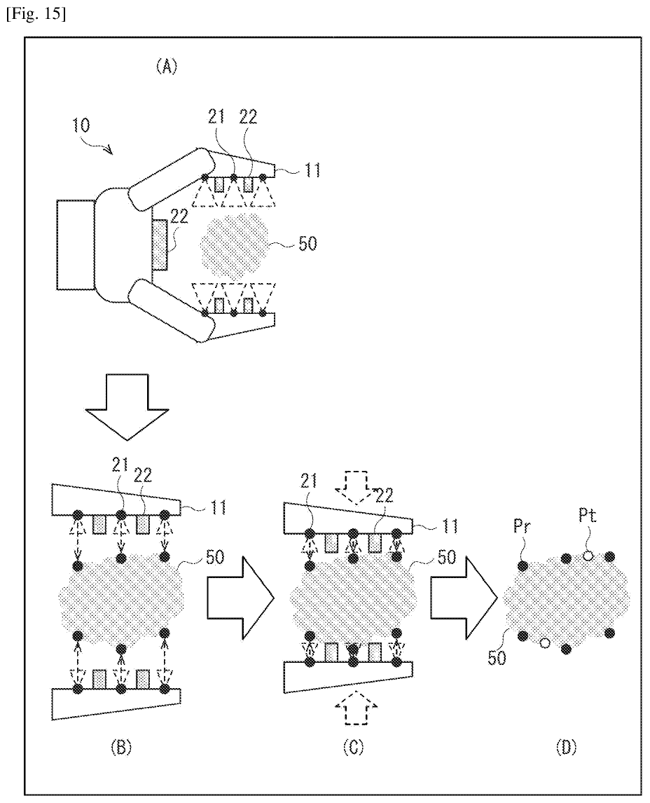

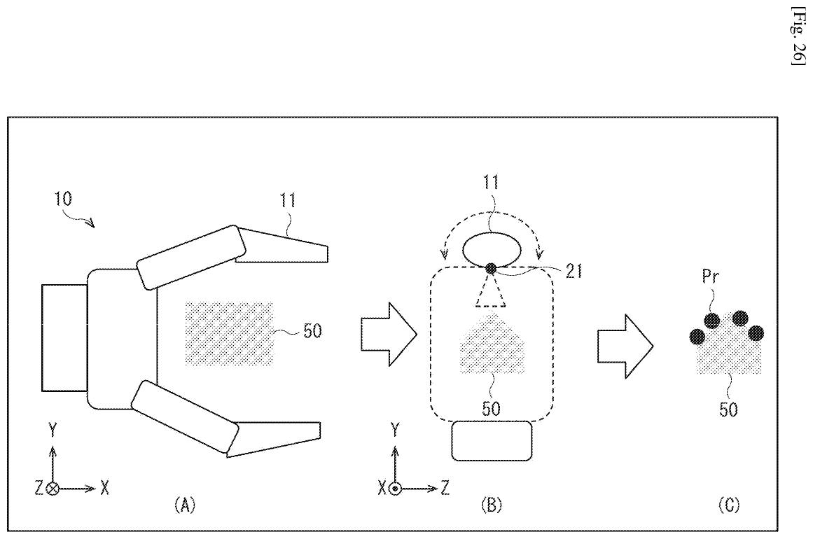

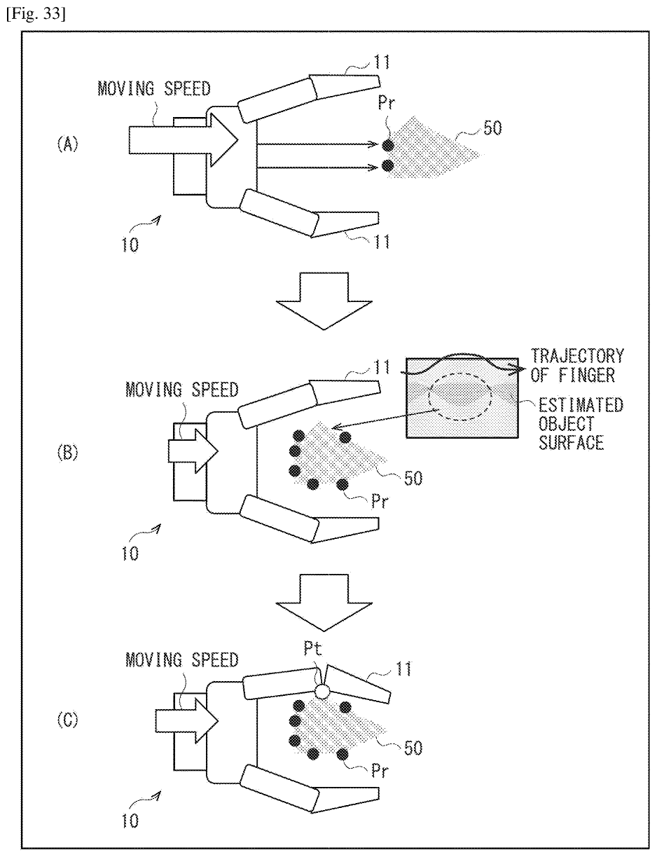

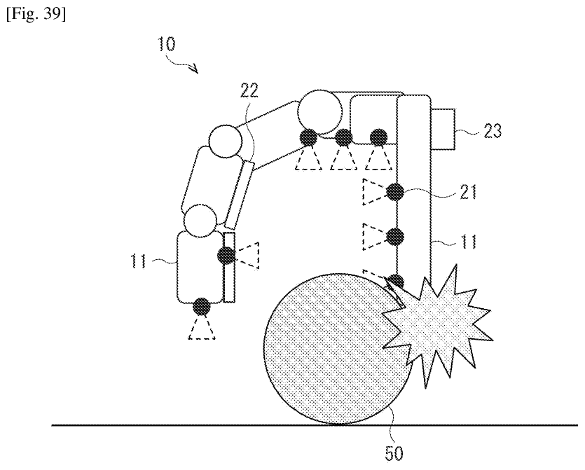

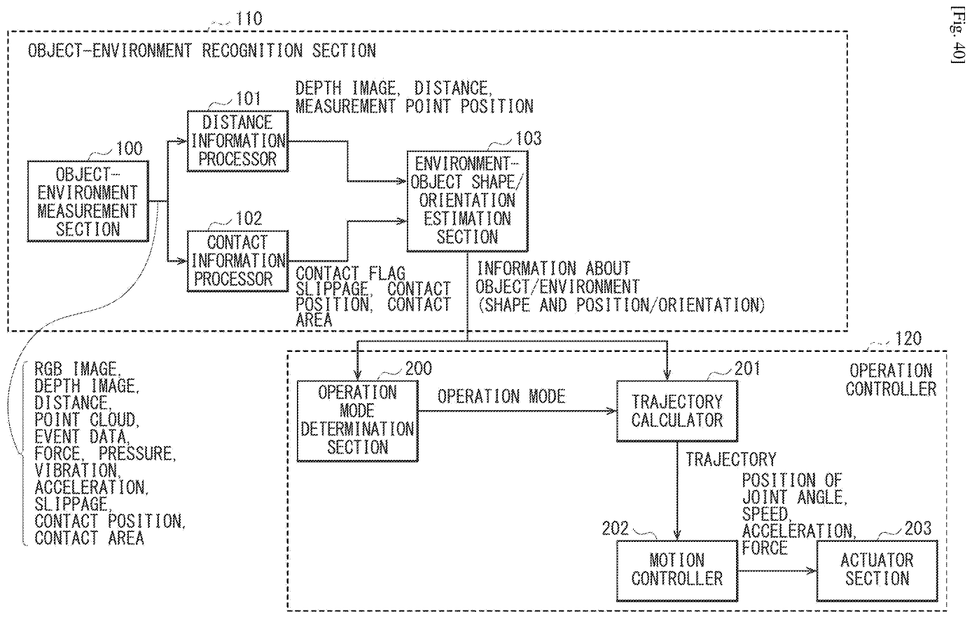

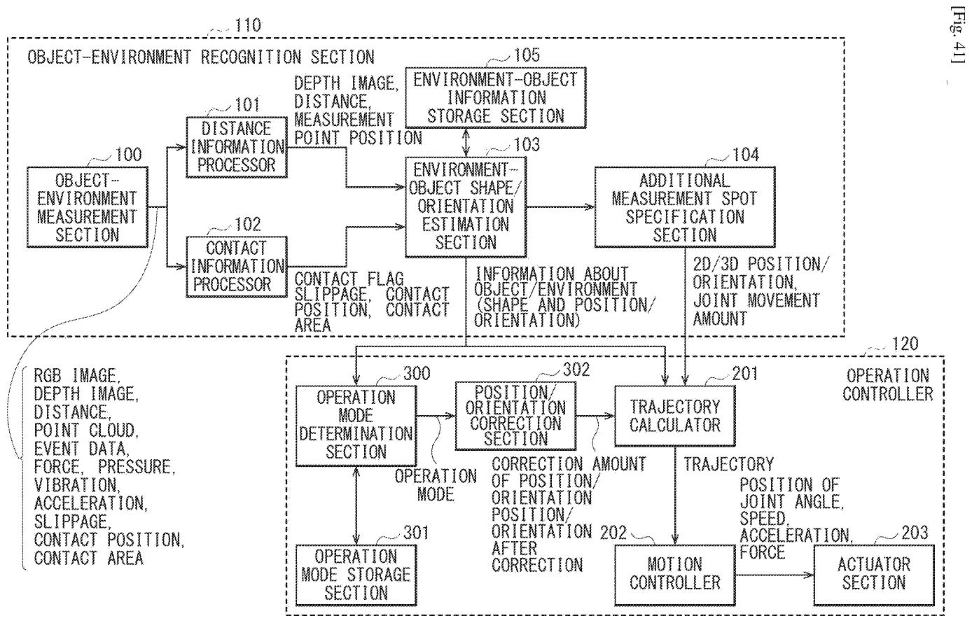

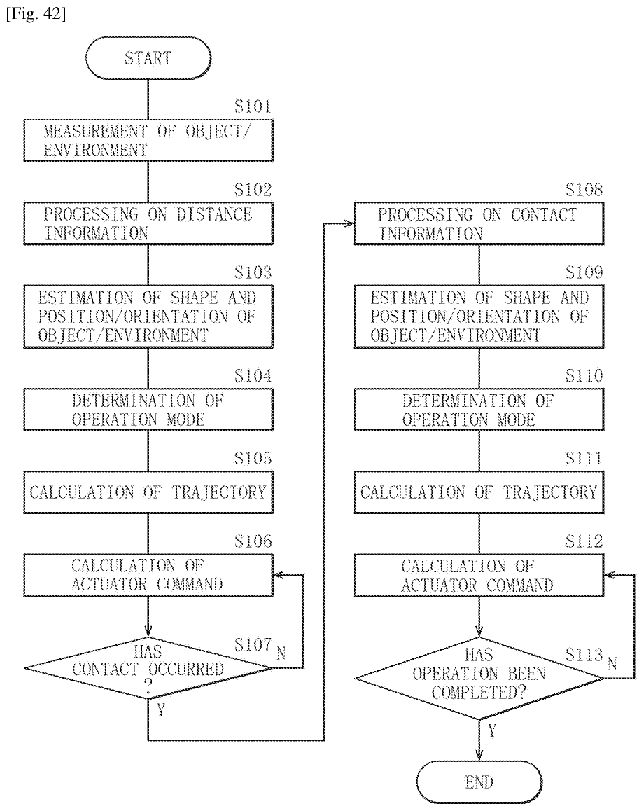

In the following, some embodiments of the present disclosure are described in detail with reference to the drawings. It is to be noted that description is given in the following order.
0. Comparative Example (FIGS. 1 and 2)
1. Embodiment
1.1 Overview (FIGS. 3 to 8)
1.2 Specific Example of Sensor Arrangement (FIGS. 9 to 14)
1.3 Specific Example of Object-environment Recognition (FIGS. 15 to 23)
1.4 Active Sensing (FIGS. 24 to 32)
1.5 Operation Generation Using Object-environment Recognition (FIGS. 33 to 38)
1.6 Use of Sensor Other Than Distance Measurement Sensor and Tactile Sensor (FIG. 39)
1.7 Configuration Example of Control Block (Robot Control Device) (FIGS. 40 to 41)
1.8 Control Operation Examples (FIGS. 42 to 44)
1.9 Effects
2. Other Embodiments

### 0. COMPARATIVE EXAMPLE

FIG. 1 and FIG. 2 are each a configuration diagram illustrating an overview of a robot system according to a comparative example.

FIGS. 1 and 2 each illustrate an example of a humanoid robot 1 having a head, a body 2, an arm 3, and a cart (a wheel) 4 as an example of a robot. A hand (a robot hand) 10 having a finger 11 is mounted on the arm 3. The finger 11 is able to grasp an object 50. A camera (a head sensor) 5 is provided on the head of the humanoid robot 1.

In such a humanoid robot 1, in order to stably grasp the object 50, it is important to select a grasping orientation or a holding way in accordance with the object 50, and recognition of a shape, and a position/orientation of the object 50 is therefore demanded. It may be difficult for a generally used RGB-D (Depth) camera to sufficiently recognize an object due to an issue of occlusion, an influence by a light source environment, an error, and the like. A distance sensor typified by a ToF (Time of Flight) sensor is an effective means. However, the distance sensor has an error, and a short distance before contact is out of a dynamic range. This results in difficulty in measurement in many cases.

In many cases, the RGB-D camera is mounted at a position apart from the object 50 (such as a head of a robot) because of an angle of view and a distance to be measured. In this case, occlusion is caused by the robot itself or an obstacle. As a distance between the sensor and the object increases, an error in recognition increases, which results in difficulty in accurate recognition. An error is caused in the shape, and the position/orientation of the recognized object 50; therefore, a grasping mode and a grasping orientation are not determined. Grasping by an optionally selected method is unstable.

In a case where various objects 50 are grasped, detailed information (a shape, a size, a position, and an orientation) about the objects 50 is unknown in many cases. An example of a technique of detecting the object 50 with the RGB-D camera is a method of detecting the object 50 with the camera 5 such as a RGB-D camera provided on the head of the humanoid robot 1, as illustrated in FIG. 1. In this case, observation from a position apart from a target is demanded by constraints on the angle of view and a distance measurement range. In addition, detailed information is not always obtainable due to occlusion caused by the robot itself or an obstacle or a disturbance caused by a light source environment.

Accordingly, use of a distance measurement sensor (a proximity sensor) is one effective means. For example, as illustrated in FIG. 2, there is a method of providing a distance measurement sensor 21 on the hand 10 or the finger 11 of the humanoid robot 1 to detect the object 50. In this case, the distance measurement sensor 21 has an error, and is difficult to be arranged in high density, and detectable objects 50 are limited.

Here, in manipulation in an unstructured environment in which information about an environment is not obtainable in advance, it is desired to handle the objects 50 having various shapes and various positions/orientations, and various obstacles. Examples of the unstructured environment include environments such as a food factory, a grocery store, a restaurant, and a hospital. In addition, it is desired to observe object information (such as the shape, and the position/orientation of the object 50) and determine an appropriate grasping mode (grasping, pinching, etc.) and an appropriate position/orientation of the robot.

Accordingly, as one embodiment, a technique is proposed of estimating information about a measurement target such as the object 50 or an environment as accurately as possible with use of a distance measurement sensor and a tactile sensor even in a case where information about the object 50, a surrounding environment, and an obstacle is not obtainable in advance. In addition, a technique is proposed of determining a grasping mode, a grasping position and a grasping orientation, an obstacle avoidance orientation, a route, and the like on the basis of the estimated information about the object 50, the surrounding environment, and the obstacle.

### 1. EMBODIMENT

### 1.1 Overview

FIGS. 3 to 8 are each a configuration diagram schematically illustrating an example of a hardware configuration of a robot system according to an embodiment of the present disclosure.

The robot system according to the embodiment includes a robot provided with the distance measurement sensor 21 and the tactile sensor 22, and a robot control device that controls the robot.

The robot control device includes a recognition section that recognizes a measurement target on the basis of distance information about the measurement target measured by the distance measurement sensor 21 provided on the robot and tactile information about the measurement target measured by the tactile sensor 22 provided on the robot. In addition, the robot control device includes a controller that performs operation control of the robot on the basis of information about the measurement target recognized by the recognition section.

In the robot system according to the embodiment, the robot control device may include, for example, a plurality of control blocks as illustrated in FIGS. 40 and 41 to be described later. In the robot system according to the embodiment, processing by the recognition section may be implemented by an object-environment recognition section 110 illustrated in FIGS. 40 and 41 to be described later. In addition, processing by the controller may be implemented by an operation controller 120 illustrated in FIGS. 40 and 41 to be described later.

A robot to be applied to the robot system according to the embodiment may be, for example, any of various mobile bodies, a legged robot, and a drone in addition to the humanoid robot 1 described above. In addition, the robot to be applied to the robot system according to the embodiment may be, for example, any of a manipulator, the hand 10, and the finger 11.

The robot system according to the embodiment includes, as the distance measurement sensor 21, at least one sensor that is able to measure a distance to the measurement target in a contactless manner. The distance measurement sensor 21 may include, for example, at least one of sensors such as a Time of Flight sensor, a millimeter wave sensor, an ultrasonic sensor, a laser sensor, a LiDAR (Light Detection And Ranging), a stereo camera, a pattern irradiation sensor, and an event-based camera.

The robot system according to the embodiment includes, as the tactile sensor 22, at least one sensor that is able to measure the measurement target by contacting the measurement target. The tactile sensor 22 may include, for example, at least one of sensors such as a pressure distribution sensor, a force sensor, a vision sensor, and a magnetic sensor.

The robot system according to the embodiment performs object-environment recognition using proximity information (distance information) by the distance measurement sensor 21 and tactile information (contact information) by the tactile sensor 22. The distance measurement sensor 21 is able to measure a distance in a contactless manner. The distance measurement sensor 21 has an error, and in the distance measurement sensor 21, detectable objects are limited, and contact with the measurement target such as the object 50 or an environment is not accurately recognized. Meanwhile, the tactile sensor 22 is able to accurately detect contact with the measurement target. In the tactile sensor 22, information is not obtained until contacting the measurement target. The robot system according to the embodiment enhances accuracy of information about the shape, the position/orientation, and the like of the measurement target such as the object 50 or an environment while using the distance measurement sensor 21 and the tactile sensor 22 differently as appropriate.

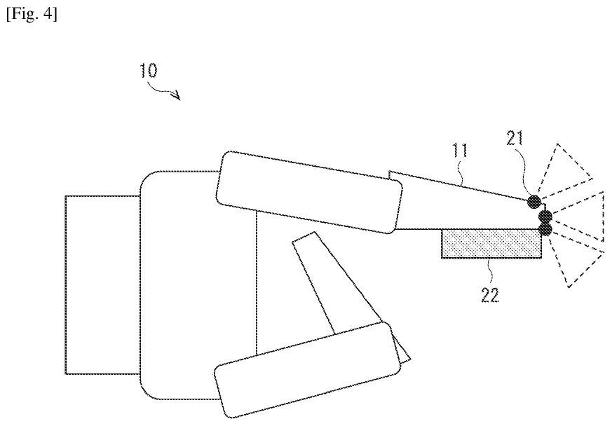

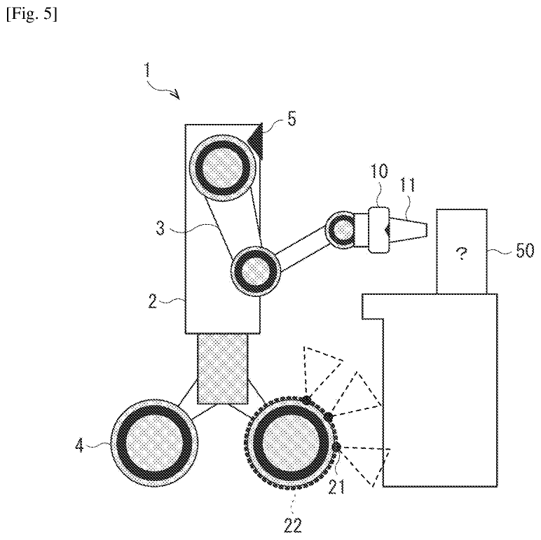

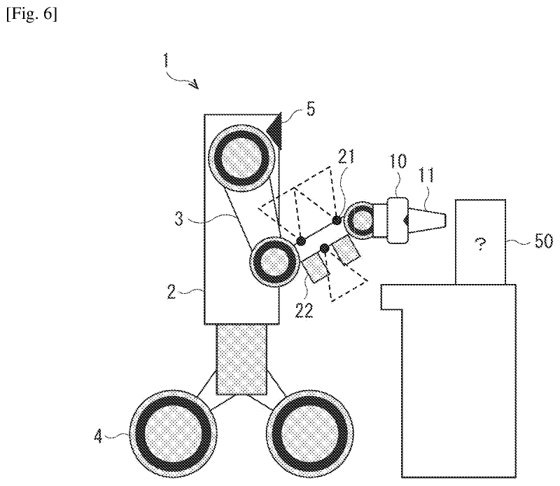

FIG. 3 illustrates an example in which the distance measurement sensor 21 and the tactile sensor 22 are provided for each of a plurality of fingers 11 of the hand 10 as a robot. FIG. 4 illustrates an example in which the distance measurement sensor 21 and the tactile sensor 22 are provided on a fingertip of one finger 11 of the hand as a robot. FIG. 5 illustrates an example in which the distance measurement sensor 21 and the tactile sensor 22 are provided on the cart (wheel) 4 in the humanoid robot 1. FIG. 6 illustrates an example in which the distance measurement sensor 21 and the tactile sensor 22 are provided on the arm 3 in the humanoid robot 1.

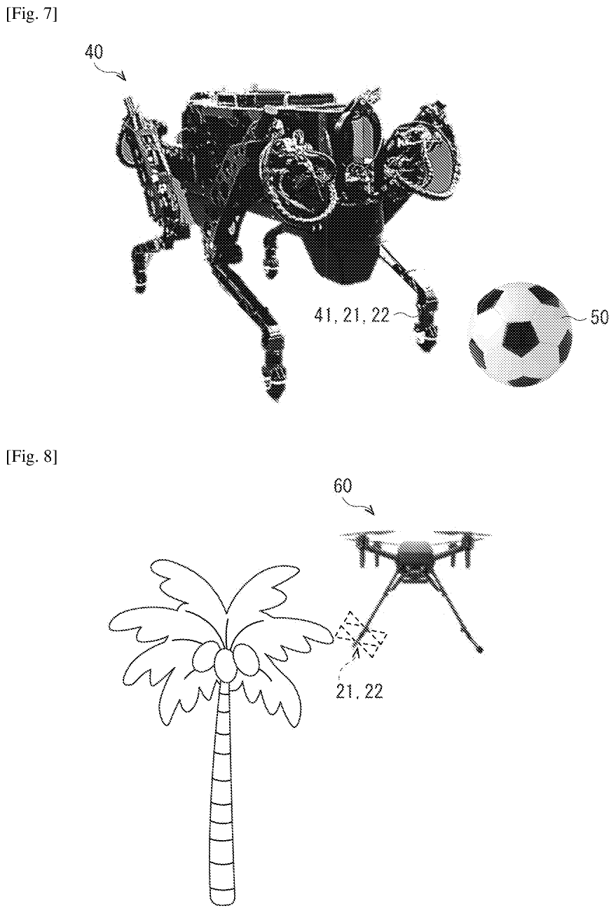

Also in a robot having any other form, the distance measurement sensor 21 and the tactile sensor 22 may be provided similarly. In a legged robot (FIG. 7), the distance measurement sensor 21 and the tactile sensor 22 may be mounted on a tip or the like of a leg 41 to sense the object 50 or an obstacle. In addition, the distance measurement sensor 21 and the tactile sensor 22 may be provided on the body 2 of the humanoid robot 1. In addition, the distance measurement sensor 21 and the tactile sensor 22 may be provided on a portion of a drone 60 (FIG. 8).

In the robot system according to the embodiment, the recognition section may recognize the shape and the position/orientation of the measurement target.

In the robot system according to the embodiment, the controller may perform, as operation control of the robot, control of at least one of an operation mode of the robot or a position/orientation of the robot.

In the robot system according to the embodiment, the robot may be configured to be able to grasp an object as the measurement target. In this case, in the robot system according to the embodiment, the controller may perform, as operation control of the robot, control of at least one of a grasping mode, a grasping position, or a grasping orientation of the measurement target by the robot.

In the robot system according to the embodiment, the robot may be configured to allow at least a part thereof to be movable. In this case, in the robot system according to the embodiment, the controller may perform, as operation control of the robot, control of at least one of a moving speed or a trajectory of at least the part of the robot.

### 1.2 Specific Example of Sensor Arrangement

Description is given below of a configuration of the hand 10 as an example of the robot; however, the technology of the robot system according to the embodiment is also applicable to a robot other than the hand 10, as described above.

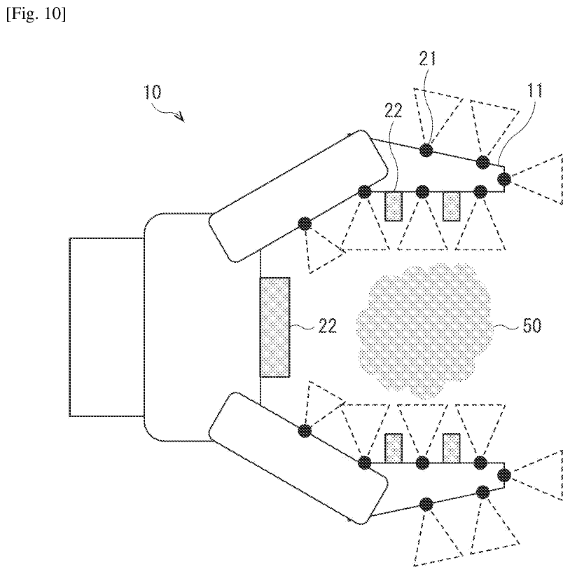

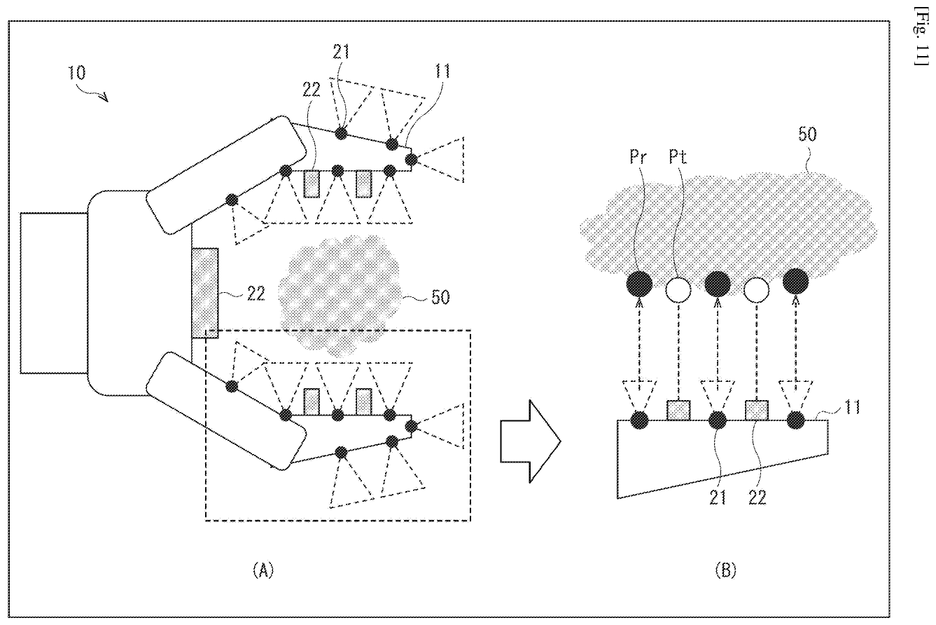

FIGS. 9 and 10 are each a configuration diagram schematically illustrating an example of a sensor arrangement in the robot system according to the embodiment.

Ideally, it is desirable that the distance measurement sensors 21 and the tactile sensors 22 be mounted on an entire body of the robot. In addition, ideally, it is desirable that the distance measurement sensor 21 and the tactile sensor 22 be provided at substantially the same place so that substantially the same place of the measurement target is measurable by the distance measurement sensor 21 and the tactile sensor 22. However, actually, the distance measurement sensor 21 and the tactile sensor 22 scramble for a mounting place, and it is difficult to provide them on the entire body. Accordingly, the distance measurement sensor 21 and the tactile sensor 22 may be disposed in consideration of respective sensor functions. For example, it is sufficient that the tactile sensor 22 is provided on a portion having a high contact frequency with the measurement target and the distance measurement sensor 21 is provided on a portion having a low contact frequency with the measurement target. In a case of the hand 10, the object 50 is grasped by a finger surface and a palm in many cases; therefore, as illustrated in FIG. 10, it is sufficient that many tactile sensors 22 are disposed on the finger surface and the palm. In addition, it is sufficient that the distance measurement sensor 21 is provided on each of the back and the front of the finger 11 as a preparation to, for example, a case where the contact frequency with the object 50 is low but it is desired to avoid contact with the object 50, and a case where alignment with the object 50 is desired.

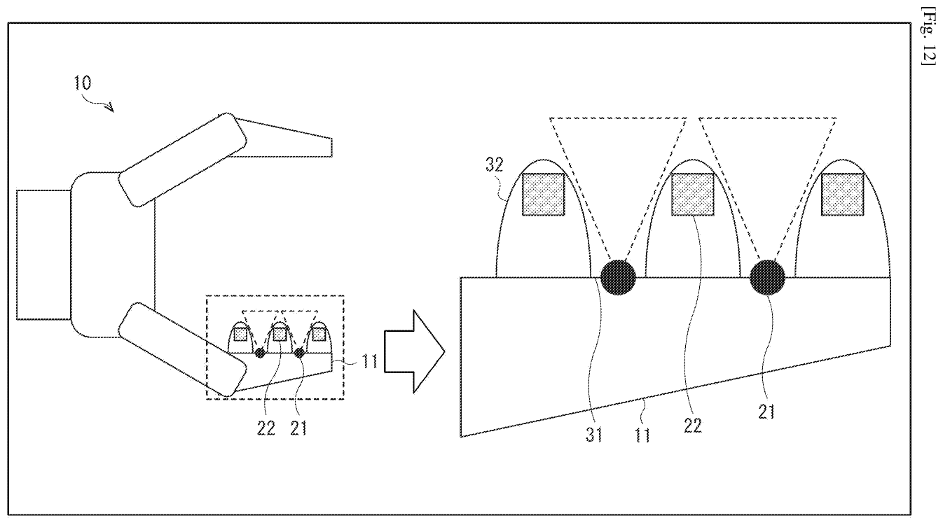

FIG. 11 is a configuration diagram schematically illustrating an example of the sensor arrangement in the robot system according to the embodiment.

In the robot in the robot system according to the embodiment, as illustrated in (A) of FIG. 11, the tactile sensors 22 and the distance measurement sensors 21 may be alternately provided. Alternately providing the tactile sensors 22 and the distance measurement sensors 21 makes it possible to enhance substantial detection resolution of the object 50 that is the measurement target. The tactile sensor 22 may be provided at a place having a high possibility of contacting the object 50, and the distance measurement sensor 21 may be provided at a place having a high possibility of not contacting the object 50. In a case where only the tactile sensor 22 is provided, measurement is difficult in a portion not contacting the object 50; therefore, using the distance measurement sensor 21 makes it possible to enhance spatial resolution at an object detection point, as illustrated in (B) of FIG. 11.

FIGS. 12 to 14 are each a configuration diagram schematically illustrating an example of the sensor arrangement in the robot system according to the embodiment.

In the robot system according to the embodiment, the robot has a protrusion part 32 and a recess part 31, and the tactile sensor 22 may be provided on the protrusion part 32, and the distance measurement sensor 21 may be provided on the recess part 31. This makes it easy to contact the object 50, and makes it possible to perform distance measurement also during object contact. In an example in FIG. 12, a surface of a fingertip having a high possibility of contacting the object 50 has a recessed and projected shape. This causes the object 50 to first contact the protrusion part 32 in object grasping, which makes it possible to reliably detect contact with the object 50 with the tactile sensor 22. In addition, measurement by the distance measurement sensor 21 is also possible. The distance measurement sensor 21 is provided on the recess part 31, and does not therefore contact the object 50.

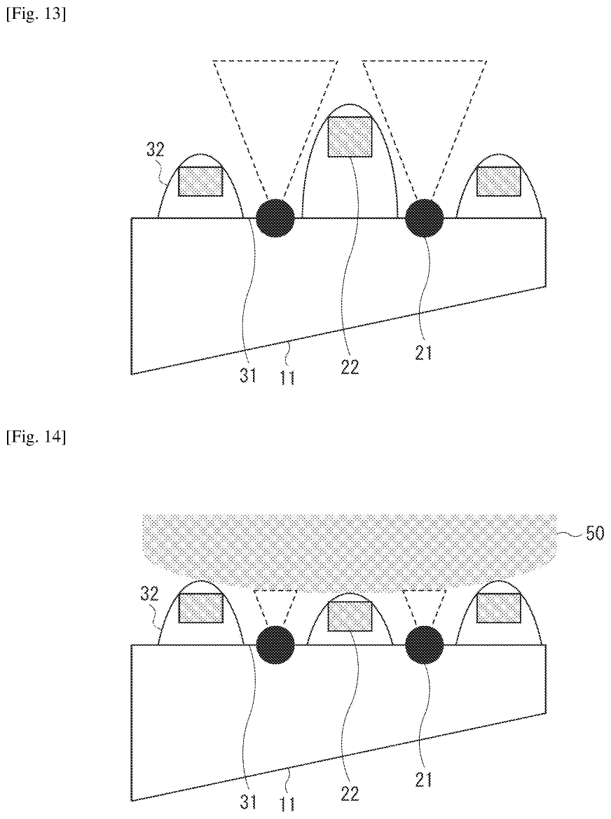

In addition, in a case where a plurality of protrusion parts 32 are provided, as illustrated in FIG. 13, the heights of the protrusion parts 32 may be partially changed. In addition, as illustrated in FIG. 14, the protrusion part 32 may include a flexible material that is to be deformed by contact with the measurement target. Using the flexible material for the protrusion part 32 makes it possible to more accurately detect contact with the object 50 having a complicated shape.

### 1.3 Specific Example of Object-Environment Recognition

### (Measuring Method)

FIG. 15 is an explanatory diagram illustrating an overview of a method of measuring the object by the robot system according to the embodiment.

Here, description is given, as an example, of a case where the object 50 that is unknown and has no prior information as a measurement target is recognized with use of the distance measurement sensor 21 and the tactile sensor 22 mounted on the hand 10 of the robot as illustrated in (A) of FIG. 15. However, the technology of the robot system according to the embodiment is also applicable to a robot other than the hand 10, as described above.

In the robot system according to the embodiment, the recognition section first roughly estimates the shape and the position/orientation of the object 50 on the basis of distance information obtained at a measurement point (a distance measurement sensor measurement point Pr) by the distance measurement sensor 21 in a contactless manner before contacting the object 50 ((B) of FIG. 15). Thereafter, the recognition section stores a spot where contact with the object 50 is detected by the tactile sensor 22 as a contact point (a tactile sensor measurement point Pt) ((C) of FIG. 15). Lastly, measurement points include the distance measurement sensor measurement point Pr detected by the distance measurement sensor 21 and the tactile sensor measurement point Pt detected by the tactile sensor 22 in a mixed manner ((D) of FIG. 15).

Information about the measurement points by the distance measurement sensor 21 and the tactile sensor 22 may be any of a distance from a finger surface, coordinates (a robot coordinate system) as viewed from a reference point of the robot, and coordinates in a world coordinate system. In a case of the tactile sensor 22, for example, it is possible to estimate a contact position in the sensor and calculate the position from information from an encoder or the like of the robot.

### (Object Shape Estimation Technique 1: Interpolation)

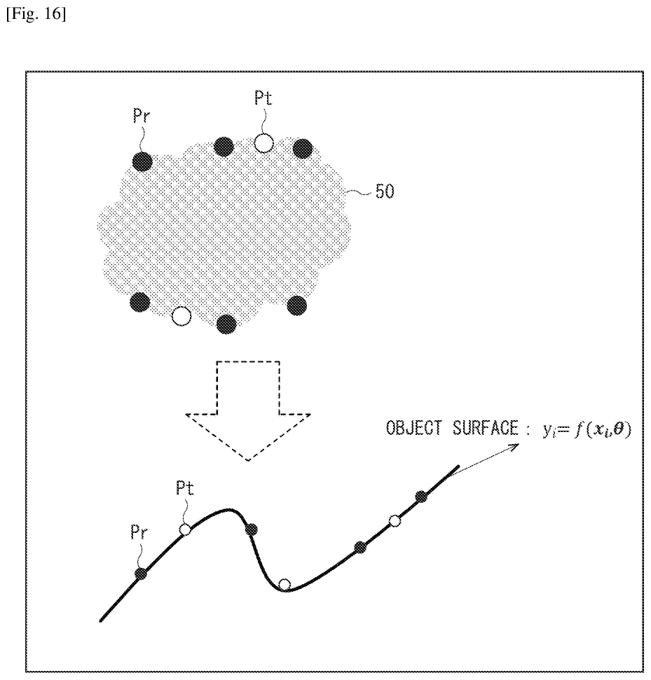

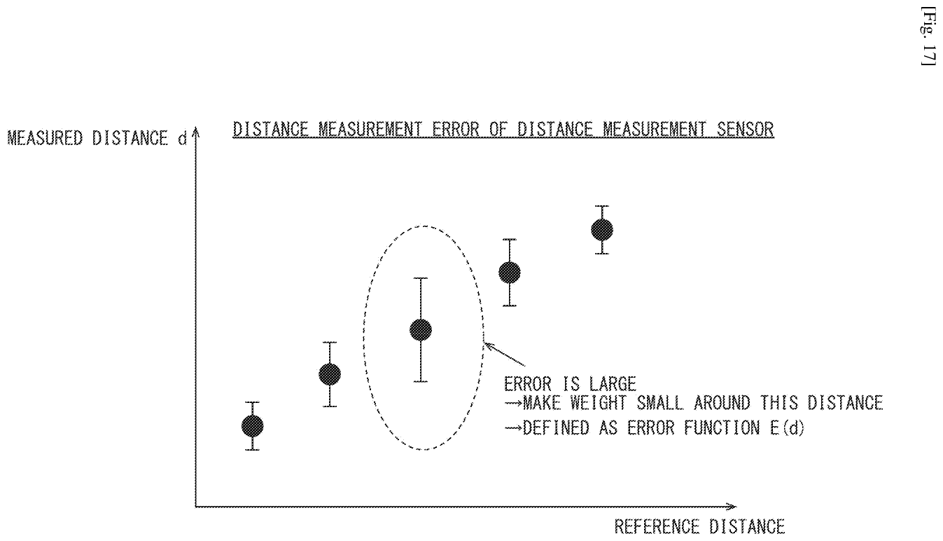

FIG. 16 is an explanatory diagram schematically illustrating an example of a technique of estimating an object shape by the robot system according to the embodiment.

In the robot system according to the embodiment, the recognition section may estimate a shape between the measurement point (the distance measurement sensor measurement point Pr) by the distance measurement sensor 21 and the measurement point (the tactile sensor measurement point Pt) by the tactile sensor 22 in the measurement target through interpolation.

The recognition section may estimate a shape of an object surface y; by performing interpolation between the measurement points without distinguishing between the distance measurement sensor measurement point Pr and the tactile sensor measurement point Pt, as illustrated in FIG. 16. Examples of an interpolation method include methods such as linear interpolation, spline interpolation, and interpolation using a radial basis function (RBF). The estimated object surface y; is represented by the following expression, where xᵢ indicates a measurement point, and θ indicates a parameter (a coefficient) of a curve showing a shape. For example, in a case where the object surface yᵢ is represented by yᵢ=axᵢ³+bxᵢ²+cxᵢ+d, θ is a, b, c, and d, and yᵢ, xᵢ, and θ are each a two-dimensional or three-dimensional vector.

$$Object surface {y}_{i} = f ( {x}_{i} , θ )$$

### (Object Shape Estimation Technique 2: Method of Weighted (Nonlinear) Least Squares)

FIG. 17 is an explanatory diagram schematically illustrating an example of a distance measurement error of the distance measurement sensor 21 in the robot system according to the embodiment. In FIG. 17, a horizontal axis indicates a reference distance, and a vertical axis indicates a measured distance.

In the robot system according to the embodiment, the recognition section may estimate the shape of the measurement target while weighting measurement points to increase weighting on the tactile sensor measurement point Pt relative to the distance measurement sensor measurement point Pr.

As illustrated in FIG. 17, in general, the distance measurement sensor measurement point Pr has an error, as compared with the tactile sensor measurement point Pt. The tactile sensor measurement point Pt is an accurate measurement point having high accuracy, as compared with the distance measurement sensor measurement point Pr. Accordingly, shape estimation in which priorities (weighting) are set by the measurement points may be performed. The priority to (weighting on) a measurement point having high accuracy may be high (large), and the priority to (weighting on) a measurement point having low accuracy may be low (small). A weighted sum of squared residuals (SSR) is represented by the following expression (1). It is sufficient that a parameter q that minimizes the SSR is determined. If the parameter θ is determined, an estimated value of the object surface yᵢ is derived.

$$\begin{matrix}[ Math . 1 ] & \\ SSR = {\sum }_{i = 1}^{n} {{w}_{i} ( {y}_{i} - f ( {x}_{i} , θ ) )}^{2} & ( 1 )\end{matrix}$$

Here, for a weight Wᵢ, a value satisfying the following expression is predefined, where, for example, W_{i_proc} is a weight of the distance measurement sensor measurement point Pr and W_{i_tac} is a weight of the tactile sensor measurement point Pt.

$${W}_{i \_ proc} < {W}_{i \_ tac}$$

The weight W_{i_proc} of the distance measurement sensor measurement point Pr may be determined from a sensor characteristic of the distance measurement sensor 21. For example, as illustrated in FIG. 17, the weight W_{i_proc} is made small around a measured distance having a large error. For example, as indicated by the following expression (2), the weight W_{i_proc} of the distance measurement sensor measurement point Pr may be determined by defining an error function E (d) corresponding to a measured distance d, where a indicates a coefficient and e indicates a minute coefficient.

$$\begin{matrix}[ Math . 2 ] & \\ {w}_{i \_ proc} = \frac{a}{E ( d ) + ε} & ( 2 )\end{matrix}$$

### (Object Shape Estimation Technique 3: Probability Distribution)

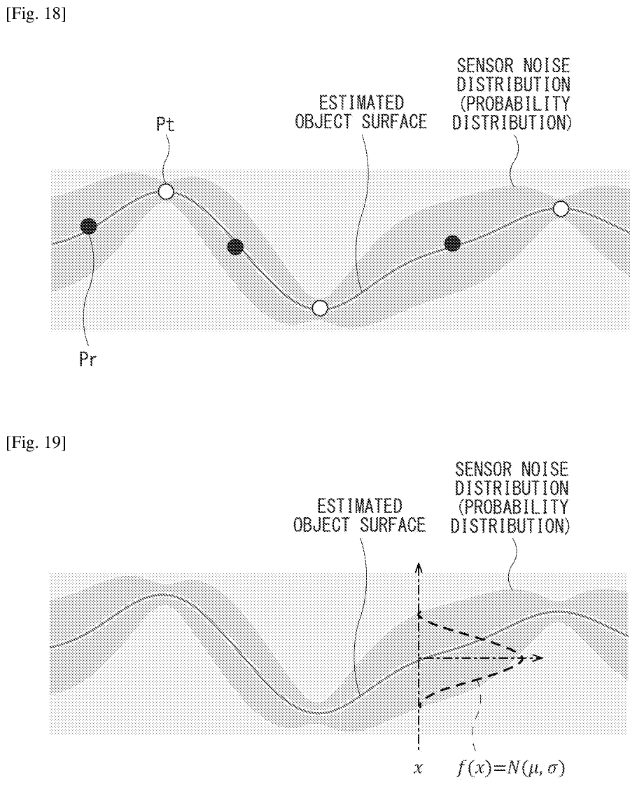

FIGS. 18 and 19 are each an explanatory diagram schematically illustrating an example of a sensor noise distribution of the distance measurement sensor measurement point Pr and the tactile sensor measurement point Pt in the robot system according to the embodiment.

In the robot system according to the embodiment, the recognition section may estimate the shape of the measurement target on the basis of a probability distribution of measurement points calculated on the basis of the distance measurement sensor measurement point Pr and the tactile sensor measurement point Pt.

As illustrated in FIGS. 18 and 19, the sensor noise distribution of the distance measurement sensor measurement point Pr and the tactile sensor measurement point Pt is considered as a probability distribution. As the sensor noise distribution of the distance measurement sensor measurement point Pr, it is assumed that an error such as a Gaussian distribution (f(x)=N(m, s)) exists, as illustrated in FIG. 19. At the tactile sensor measurement point Pt, an error thereof is small, and a width of an expected probability distribution therefore becomes small. Having the probability distribution makes it possible to consider uncertainty such as a measurement error. For example, for a spot where an error exists and an object surface position is not accurately known, as illustrated in FIG. 33 to be described later, it is possible to perform control adjustment such as decreasing a contact speed (e.g., an operation speed (a moving speed) of the hand 10).

(Object Shape Estimation Technique 4: Estimation of Entire Shape from Partial Observation Information (with No Prior Object Information))

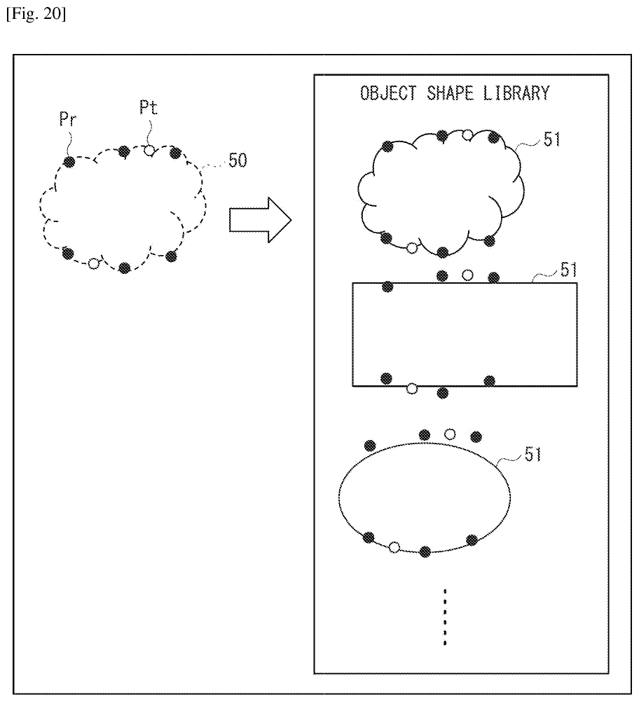

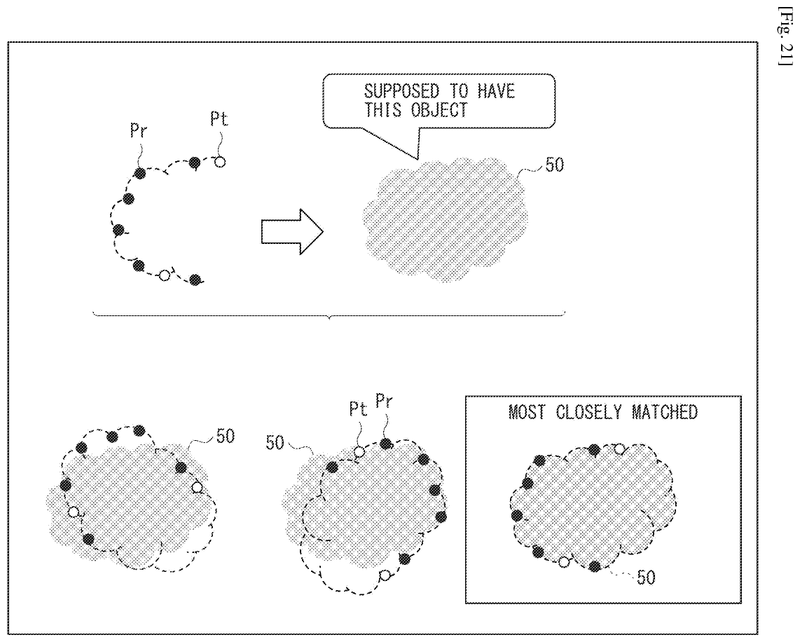

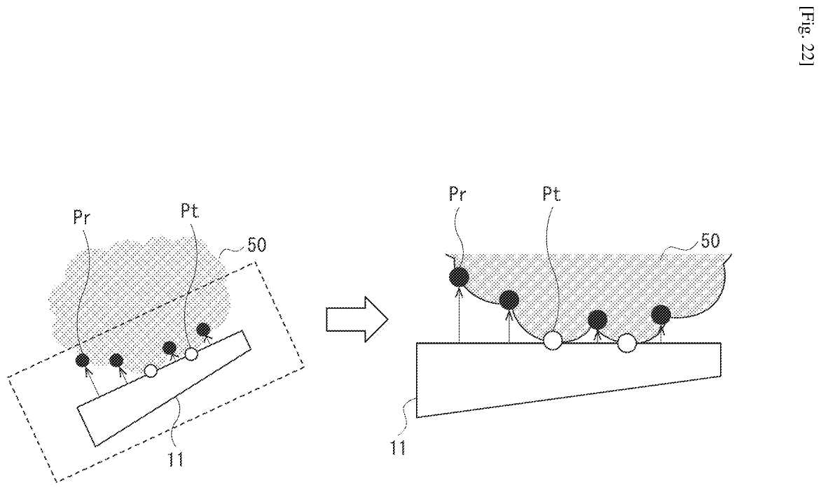

FIG. 20 is an explanatory diagram schematically illustrating an example of the technique of estimating an object shape by the robot system according to the embodiment.

In the robot system according to the embodiment, the recognition section may estimate an entire shape of the measurement target on the basis of partial observation information about the measurement target by the distance measurement sensor 21 and the tactile sensor 22. For example, the recognition section may estimate the entire shape of the measurement target by performing pattern matching between information about a plurality of template objects 51 prepared in advance and partial observation information about the measurement target by the distance measurement sensor 21 and the tactile sensor 22.

In a case where no prior information about the object 50 that is the measurement target is present, the entire shape may be estimated from the partial observation information about the object 50. As illustrated in FIG. 20, for example, the entire shape may be estimated by achieving pattern matching between partially observed measurement points (the distance measurement sensor measurement point Pr and the tactile sensor measurement point Pt) and a template object 51 in a predefined object shape library. A shape having the highest matching score is adopted as an estimated shape of the object 50. As a pattern matching method, it is possible to use a typical template matching technique or the like.

(Object Shape Estimation Technique 5: Estimation of Entire Shape from Partial Observation Information (with Prior Object Information))

FIG. 21 is an explanatory diagram schematically illustrating an example of the technique of estimating an object shape by the robot system according to the embodiment.

In the robot system according to the embodiment, the recognition section may estimate the entire shape and the position/orientation of the measurement target by performing pattern matching between prior information about the measurement target and partial observation information about the measurement target by the distance measurement sensor 21 and the tactile sensor 22.

For example, as illustrated in FIG. 21, in a case where the shape, an object name, or the like of the object 50 to be grasped is known in advance, it is possible to estimate the shape and the position/orientation of the object 50 that is the measurement target by achieving pattern matching between the partial observation information and object information known in advance and interpolating information about a portion that has not been observed. As an example of a pattern matching technique, it is possible to use, for example, a technique using deep learning, an ICP (Iterative Closest Point), or the like.

(Object Shape Estimation Technique 6: Estimation of Entire Shape from Partial Observation Information (Modification Example))

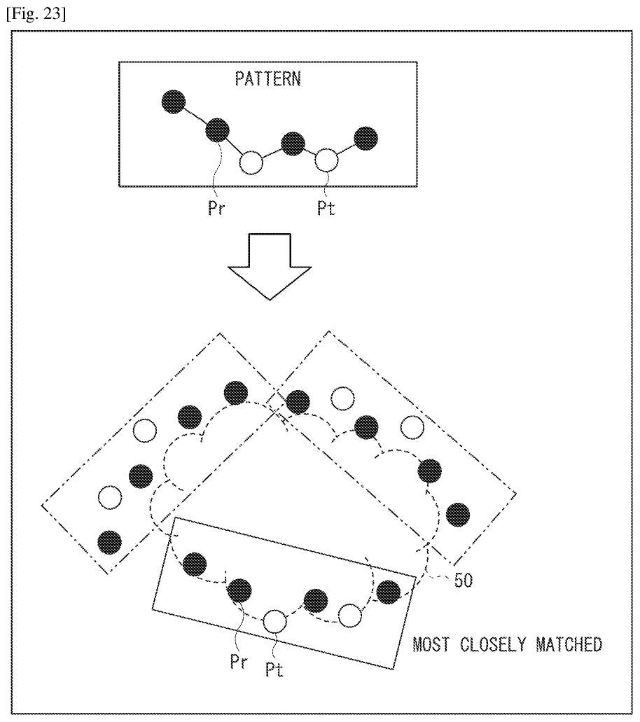

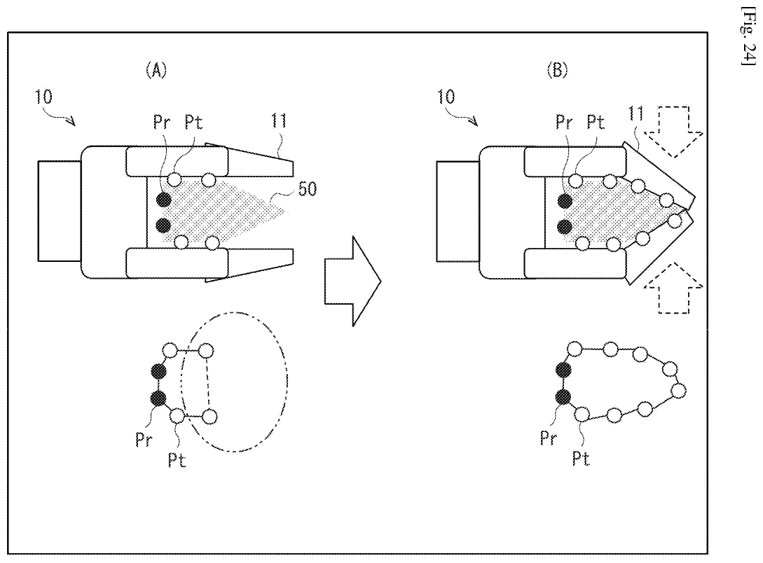

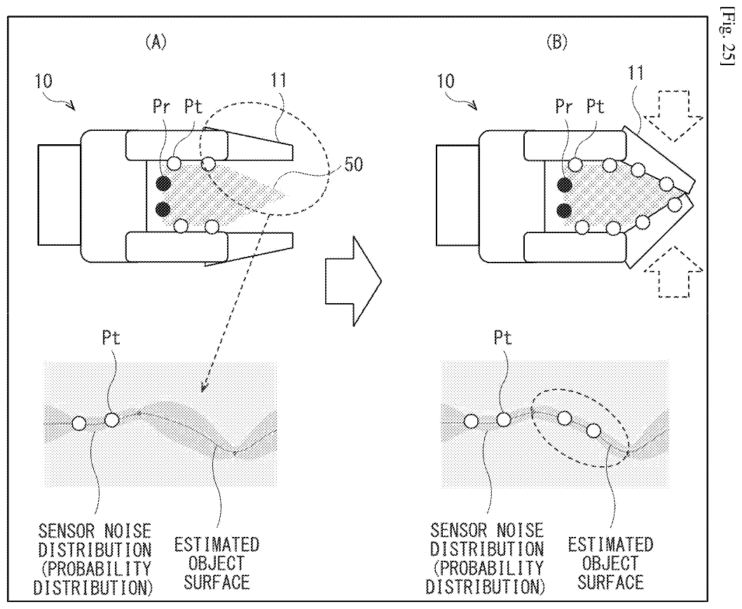

FIGS. 22 and 23 are each an explanatory diagram schematically illustrating an example of the technique of estimating an object shape by the robot system according to the embodiment.

In the robot system according to the embodiment, the recognition section may perform estimation using a combination of the object shape estimation technique 4 and the object shape estimation technique 5 described above. As illustrated in FIG. 22, for example, in a case where, in performing object grasping with the finger 11 provided with the distance measurement sensor 21 and the tactile sensor 22, the object 50 that is the measurement target has recesses and protrusions, a portion where the distance measurement sensor 21 or the tactile sensor 22 contacts the object 50 and a portion where the distance measurement sensor 21 or the tactile sensor 22 does not contact the object 50 are present. In this case, measurement point distribution patterns of the distance measurement sensor measurement point Pr and the tactile sensor measurement point Pt each serve as information for recognizing the object shape.

Accordingly, as illustrated in FIG. 23, the shape and the position/orientation of the object 50 that is the measurement target may be estimated by using the distribution pattern of the distance measurement sensor measurement point Pr and the distribution pattern of the tactile sensor measurement point Pt for pattern matching. In this case, information about the measurement point distribution patterns may be added to a pattern matching library.

### 1.4 Active Sensing

### Example 1 of Active Sensing

FIGS. 24 and 25 are each an explanatory diagram schematically illustrating an example 1 of active sensing by the robot system according to the embodiment.

In the robot system according to the embodiment, the robot may be configured so as to allow at least a part thereof provided with the distance measurement sensor 21 or the tactile sensor 22 to be movable. In the robot system according to the embodiment, the controller may perform operation control of at least the part provided with the distance measurement sensor 21 or the tactile sensor 22 so as to locate the distance measurement sensor measurement point Pr or the tactile sensor measurement point Pt at a spot where measurement of the measurement target by the distance measurement sensor 21 or the tactile sensor 22 is insufficient.

In a case where the part provided with the distance measurement sensor 21 or the tactile sensor 22 is movable, the measurement target such as the object 50 or an environment may be measured by moving the part so as to locate the measurement point by the distance measurement sensor 21 or the tactile sensor 22 at a spot where measurement is insufficient or a place where uncertainty of measurement is high.

In an example in (A) of FIG. 24, it is possible to observe a shape of a portion of the object 50 around a base of the finger 11 by the distance measurement sensor measurement point Pr or the tactile sensor measurement point Pt; however, there is a possibility that the number of measurement points of the object 50 provided around a tip of the finger 11 is small and it is not possible to accurately observe the shape around the tip of the finger 11. In this case, as illustrated in (B) of FIG. 24, a portion around the tip of the finger 11 is moved close to the object 50, which makes it possible to observe the shape of the object 50 around the tip of the finger 11. It is possible to determine the “possibility that the number of measurement points is small”, for example, by an interval between the measurement points, density of the measurement points, comparison with prior information, comparison with a shape estimated from RGB data, or the like.

In addition, in a case where the probability distribution is used for object shape estimation as illustrated in (A) of FIG. 25, it is sufficient that the finger 11 of the hand 10 is operated to search for a portion where uncertainty is large as illustrated in (B) of FIG. 25. At this time, uncertainty is smaller in measurement by the tactile sensor 22; therefore, it is sufficient that the finger 11 is controlled so as to cause the tactile sensor 22 to contact the object 50.

### Example 2 of Active Sensing

FIG. 26 is an explanatory diagram schematically illustrating an example 2 of active sensing by the robot system according to the embodiment. (B) of FIG. 26 and (C) of FIG. 26 each illustrate a state as viewed from an X-axis direction in (A) of FIG. 26.

In a case where it is possible to move the part provided with the distance measurement sensor 21 or the tactile sensor 22, it is possible to obtain a wider range of information about the measurement target such as the object 50 or an environment by rotating or translationally moving the part. For example, a case is considered where the object 50 is measured by the distance measurement sensor 21 mounted on the finger 11 of the hand 10 as illustrated in (A) of FIG. 26. For example, in a case where the finger 11 is rotatable around an axis parallel to an X axis as a rotation axis as illustrated in (B) of FIG. 26, measurement is performed while rotating the finger 11 provided with the distance measurement sensor 21, which makes it possible to successively obtain data of the object 50 at different positions by one distance measurement sensor 21 as illustrated in (C) of FIG. 26. Accordingly, even in a case where the number of mounted sensors is small, it is possible to detect the object surface in a wide range. In addition, it is possible to reconfigure information about the measurement target such as the object 50 or an environment by integrating a plurality of pieces of measurement information from a plurality of sensors obtained from the distance measurement sensors 21 or the tactile sensors 22 mounted at different positions.

### Example 3 of Active Sensing

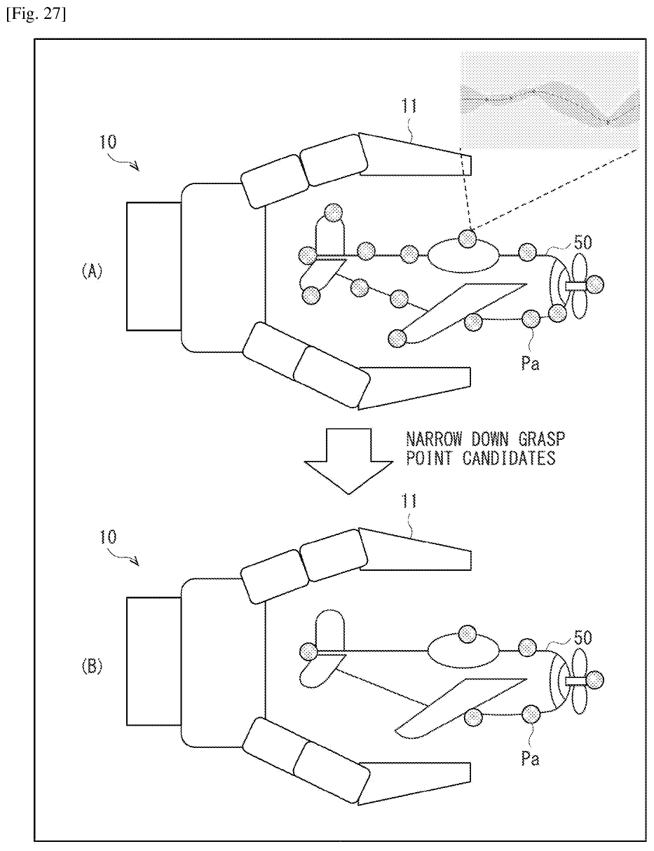

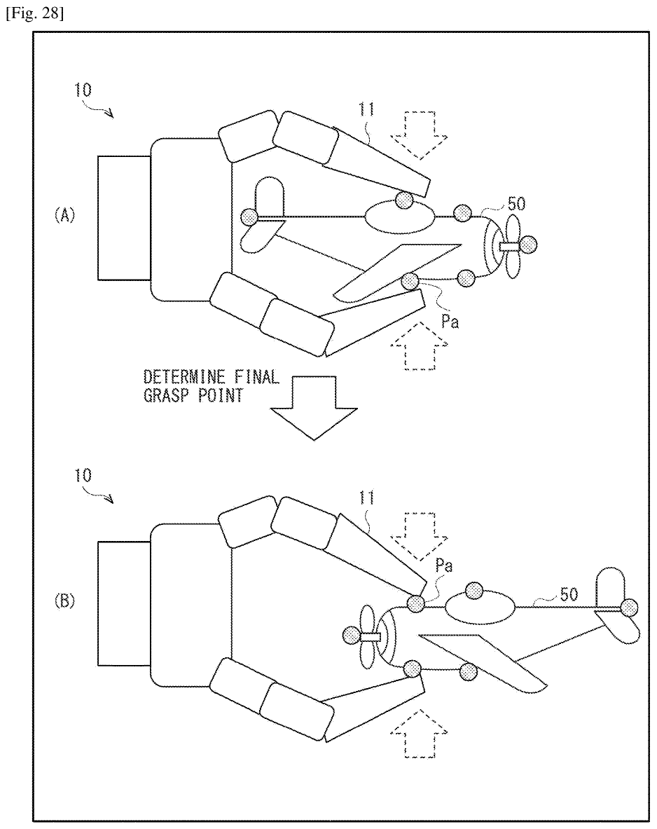

FIGS. 27 and 28 are each an explanatory diagram schematically illustrating an example 3 of active sensing by the robot system according to the embodiment.

In the robot system according to the embodiment, after performing operation control of the robot on the basis of distance information measured before contacting the measurement target, the controller may correct operation control of the robot on the basis of tactile information measured after contacting the measurement target. In the robot system according to the embodiment, the robot may be configured to be able to grasp the object as the measurement target. In this case, the controller may perform operation control of the robot so as to determine a grasp point in consideration of grasp stability from among a plurality of grasp candidate points Pa on the basis of information about the measurement target recognized by the recognition section, and grasp the object as the measurement target at the determined grasp point.

For example, in a case of object grasping, a position of the grasp point and a surface direction of the position, rigidity, and a friction coefficient significantly affect grasp stability; therefore, it is desired to determine the grasp point in consideration of grasp stability. In a case where a large number of grasp candidate points Pa are present, it is possible to narrow down to a final grasp point with use of the distance measurement sensor 21 and the tactile sensor 22. For example, it is possible to narrow down the grasp points by the following procedures, for example.

(Narrowing Down Procedure 1) First, the distance measurement sensor 21 roughly estimates the shape of the object ((A) of FIG. 27). Any of the estimation techniques described above may be used.

(Narrowing Down Procedure 2) Thereafter, the grasp candidate points Pa are narrowed down in consideration of grasp stability ((B) of FIG. 27).

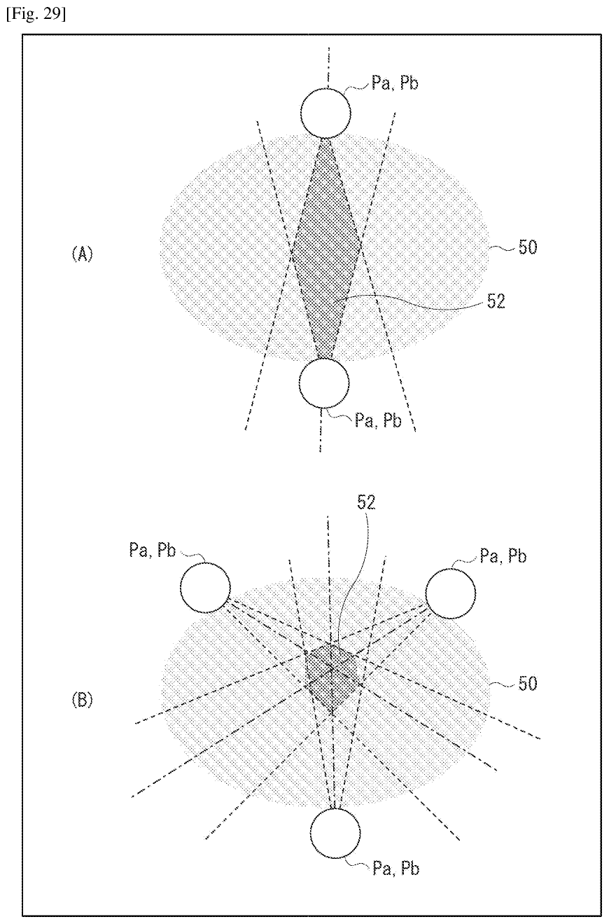

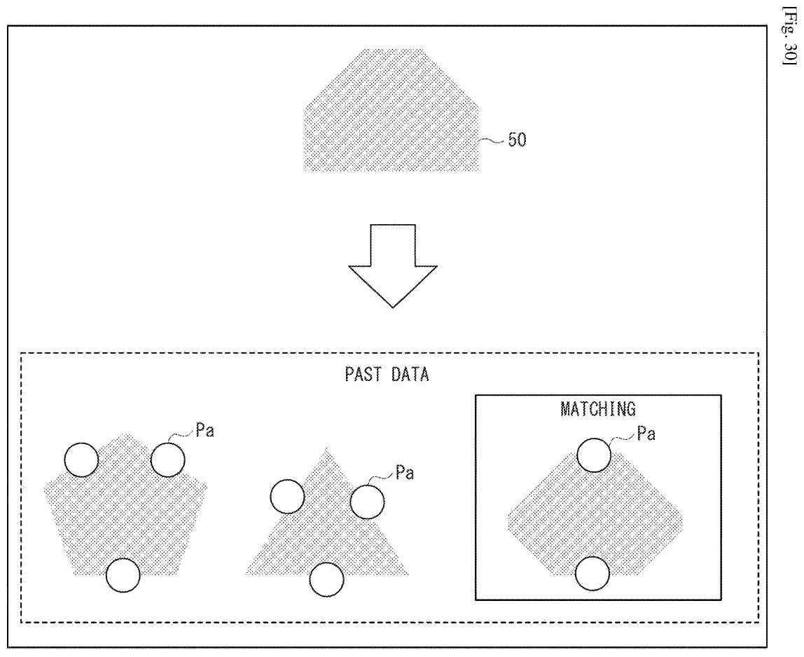

FIG. 29 is an explanatory diagram schematically illustrating a first method of narrowing down the grasp candidate points Pa in consideration of grasp stability by the robot system according to the embodiment. FIG. 30 is an explanatory diagram schematically illustrating a second method of narrowing down the grasp candidate points Pa in consideration of grasp stability by the robot system according to the embodiment.

A technique of estimating grasp stability is a method of considering that grasp stability is achieved in a state of force closure. A first method of narrowing down the grasp candidate points Pa is a method of narrowing down the grasp candidate points Pa to cause a straight line connecting the contact points Pb or an intersection of straight lines extending in a normal direction from the contact points Pb to be present within a region 52 surrounded by a friction cone, as illustrated in (A) of FIG. 29 and (B) of FIG. 29. In addition, a second method of narrowing down the grasp candidate points Pa is a method of matching against data of grasp points at which grasping has been performed, and adopting a grasping position in data having a high degree of matching as the grasp candidate point Pa, as illustrated in FIG. 30.

(Narrowing Down Procedure 3) Thereafter, the tactile sensor 22 contacts the narrowed-down grasp candidate point Pa to measure an accurate position, rigidity at that point, and slipperiness (a friction coefficient) ((A) of FIG. 28). It is possible to estimate rigidity from a reaction force and magnitude of deformation during contact. The friction coefficient is determined by comparison between a shear force and a force in the normal direction when slipping starts in a case of applying a force in a shear direction after contact.

(Narrowing Down Procedure 4) Thereafter, a final grasp point is determined from among the grasp candidate points Pa ((B) of FIG. 28).

### Example 4 of Active Sensing

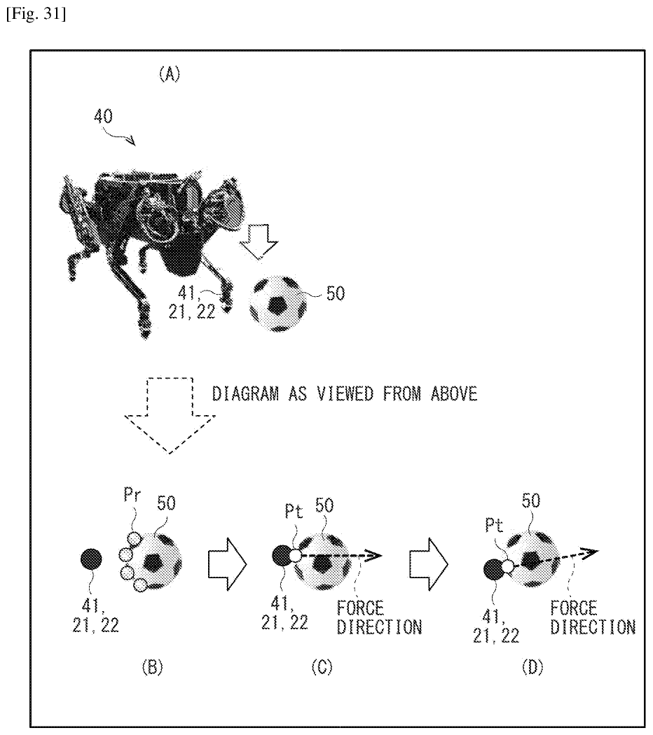

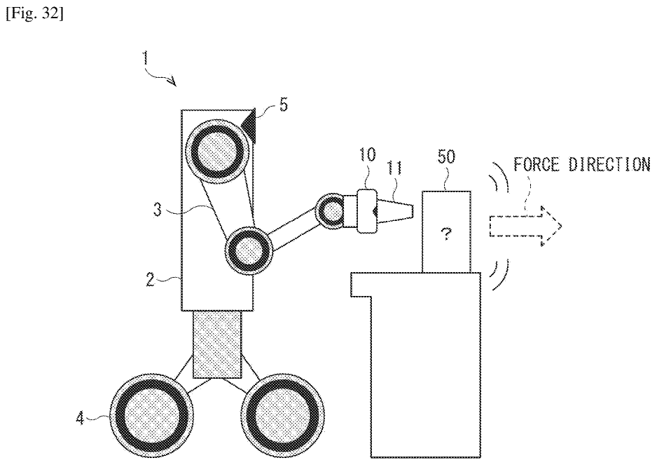

FIGS. 31 and 32 are each an explanatory diagram schematically illustrating an example 4 of active sensing by the robot system according to the embodiment.

(A) of FIG. 31 illustrates an operation of kicking a ball as the object with the leg 41 of a legged robot 40 as an example. (B) to (D) of FIG. 31 each schematically illustrate a state around the leg 41 of the legged robot 40 as viewed from above.

Active sensing is also applicable to an operation other than grasping. For example, active sensing is applicable to an operation of kicking a ball as the object 50 with the leg 41 of the legged robot 40 ((A) of FIG. 31), an operation of pushing the object 50 with the hand 10 of the humanoid robot 1 (FIG. 32), and the like. For example, it is possible to narrow down contact points and force directions by the distance measurement sensor 21 ((B) of FIG. 31), and determine a contact point and a force direction by the tactile sensor 22 ((C) and (D) of FIG. 31). If the direction of a contact surface is different from an expected direction due to an error of the distance measurement sensor 21 and this is found during contact, it is possible to adopt information during contact to adjust the force direction.

In addition, sensing similar to the examples 1 to 4 of active sensing described above is applicable to operations of the arm 3 and the cart 4 (FIGS. 5 and 6) of the humanoid robot 1 provided with the distance measurement sensor 21 and the tactile sensor 22. The sensing is also applicable to an operation of the drone 60 (FIG. 8) provided with the distance measurement sensor 21 and the tactile sensor 22.

### 1.5 Operation Generation Using Object-Environment Recognition

### (Trajectory Plan Using Uncertainty Information)

FIG. 33 is an explanatory diagram illustrating an example of an operation of moving the hand 10 close to the object 50 that is the measurement target in the robot system according to the embodiment.

Upon moving the hand 10 close to the measurement target such as the object 50 or an environment, first, a distance to the measurement target and the shape of the measurement target are estimated on the basis of the distance measurement sensor measurement point Pr ((A) of FIG. 33 and (B) of FIG. 33). However, measurement by the distance measurement sensor 21 has an error, which may cause a collision with the measurement target in some cases ((C) of FIG. 33). Accordingly, an operation speed (a moving speed) or a trajectory of the hand 10 may be adjusted in accordance with uncertainty. For example, in a case where uncertainty arises, the moving speed may be decreased to move the hand 10 close to the measurement target along a trajectory having a larger margin than a measured distance.

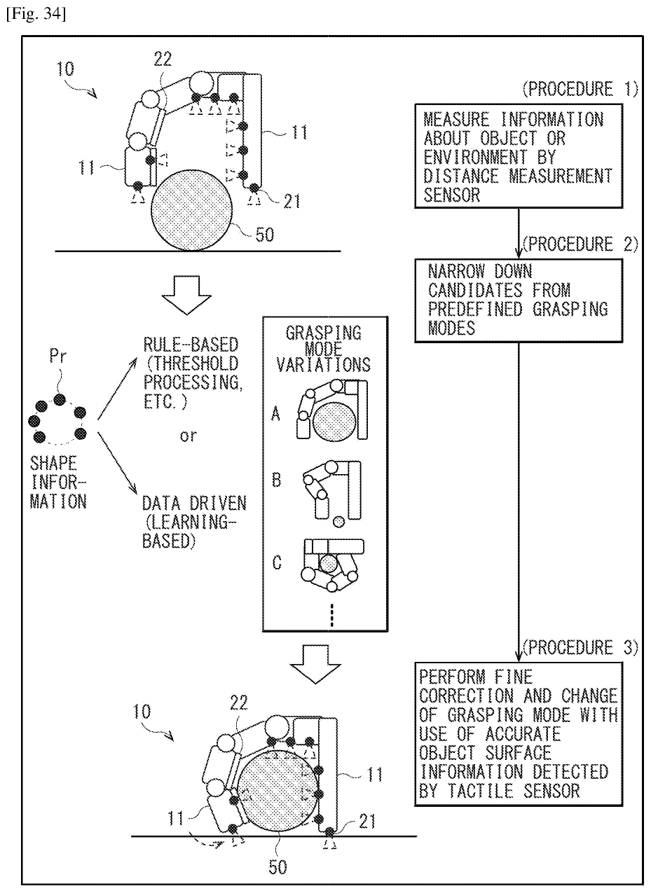

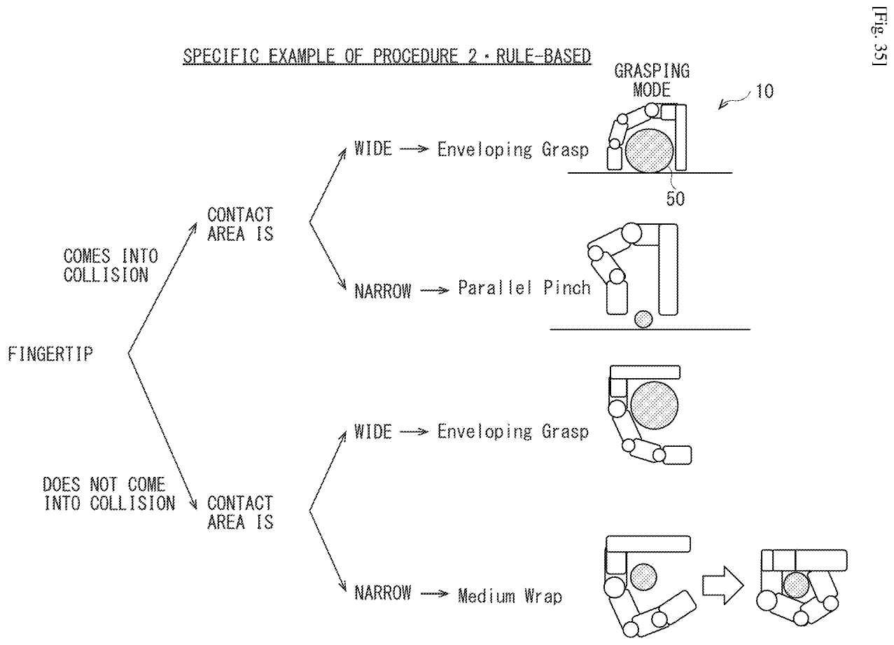

FIG. 34 is an explanatory diagram illustrating an example of a technique of determining a grasping mode with use of an object environment recognition result including uncertainty information in the robot system according to the embodiment.

In a case of object grasping, various approaches (approach operations) and grasping modes are considered depending on a degree-of-freedom structure of the finger 11 and the number of fingers 11. It is sufficient that they are appropriately determined in accordance with the shape and a mass friction coefficient of the object 50. Here, a technique is proposed of performing fine correction of the grasping mode and changing the grasping mode with use of the tactile sensor 22 after estimating an appropriate grasping mode with use of the distance measurement sensor 21.

First, information about the measurement target such as the object 50 or an environment is measured by the distance measurement sensor 21 (a procedure 1). Any of the techniques described above may be used as a measurement technique. The obtained information about the measurement target includes uncertainty.

Thereafter, candidates are narrowed down from predefined grasping modes (a procedure 2). Examples of a narrowing down method include a rule-based method and a learning-based (data driven) method. In the rule-based method, each of parameters related to the shape of the object 50 is defined and is set to a threshold to narrow down grasping modes. In the learning-based method, a model (which may be a NN (Neural Network)) is learned in which shape information about the object 50 including uncertainty is regarded as an input (which may include not only an estimated shape but also information such as dispersion) and a grasping mode is regarded as an output. In the learning-based method, an evaluation value is outputted.

Thereafter, fine correction and change of the grasping mode are performed with use of accurate object surface information detected by the tactile sensor 22 (a procedure 3). In a case where another grasping mode becomes appropriate in object shape updating by information from the tactile sensor 22, an action of changing the grasping mode is performed. If it is better to correct a position or an orientation for stable grasping even in the same grasping mode, such correction is performed. It is sufficient that an index of grasp stability uses the concept of force closure (FIG. 29) described above.

### Specific Example of Procedure 2 (Rule-Based)

FIG. 35 is an explanatory diagram illustrating a specific example of the procedure 2 (rule-based) illustrated in FIG. 34.

In an example in FIG. 35, one of Enveloping Grasp (enveloping grasp), Parallel Pinch, and Medium Wrap is determined as a grasping mode in accordance with whether or not a fingertip comes into collision and whether a contact area is wide or narrow.

### Specific Example of Procedure 2 (Learning-Based)

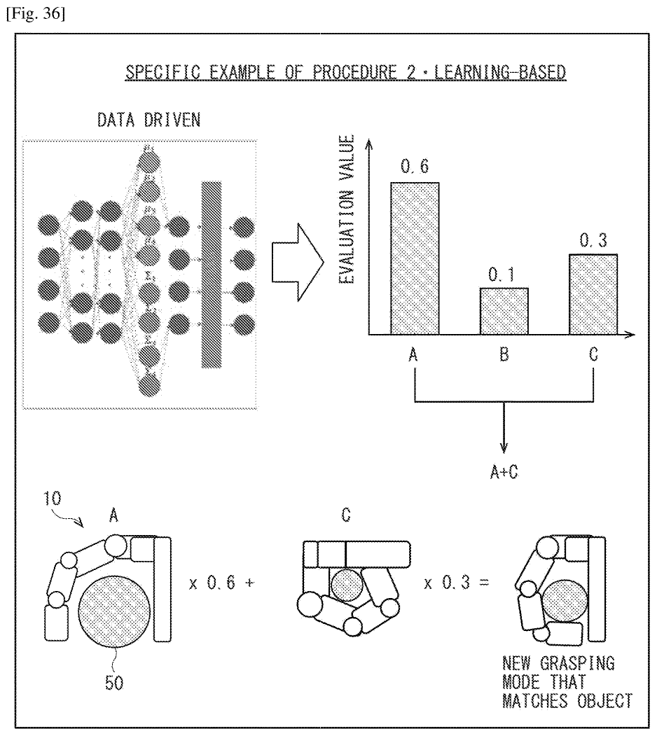

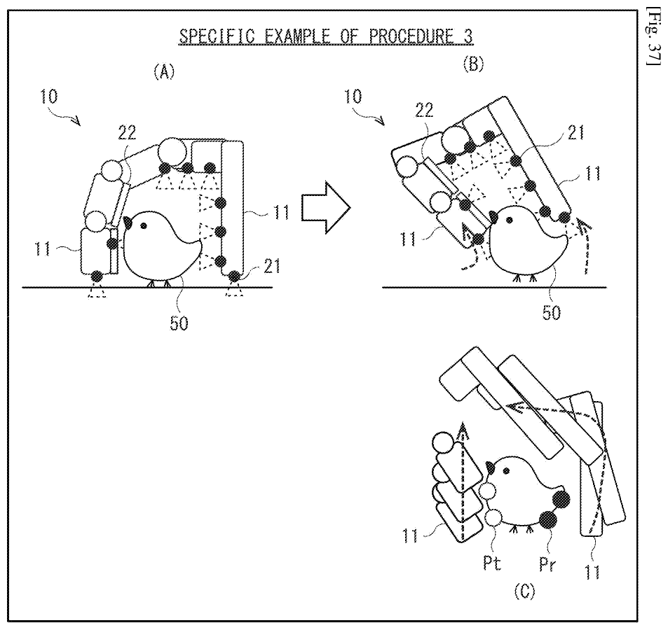

FIG. 36 is an explanatory diagram illustrating a specific example (learning-based) of the procedure 2 illustrated in FIG. 34.

As an advantage of using a learning-based grasping mode determination method, it is possible to newly create a more optimal grasping mode. In the rule-based method, which grasping mode is to be adopted is a discrete classification problem, and is uniquely decided. In the learning-based method, an evaluation value of each grasping mode is calculated. Also in the learning-based method, in a case where the largest evaluation value is selected, which grasping mode is to be adopted is a discrete classification problem. It is possible to generate an intermediate mode between different grasping modes in accordance with the evaluation value. In an example in FIG. 36, a grasping mode A and a grasping mode C are combined to create a new intermediate grasping mode that matches the object 50. In the example in FIG. 36, a new intermediate grasping mode including 60% of the grasping mode A and 30% of the grasping mode C is generated.

### (Different Uses of Learning-Based Method and Rule-Based Method)

For example, the rule-based method may be used in the following cases.
A case where it is possible to make a classification into Primitive shapes (a rectangular parallelepiped, a sphere, a cylinder, a cone, etc.) predefined by a human by an object recognition result
A case where a request for a grasping method (such as a request to pinch the object 50 having a specific shape so as to reduce a contact area) is made from a user and it is desired to reliably select a specified grasping mode

In addition, for example, the learning-based method may be used in the following cases.
A case where a complicated shape makes it difficult to create a rule for determining a grasping mode
A case where sensors are not tightly mounted due to space limitations, and a case where it is desired to interpolate missing information, such as an environment that easily causes occlusion

As another rule for different uses, for example, the object 50 for which the grasping mode is not determined in the rule-based method (which does not conform to a preset rule) may be processed in the learning-based method. In addition, a grasping mode determined in the rule-based method and a grasping mode determined in the learning-based method may be made coincident with each other, and in a case where the grasping modes are different, judgment may be left to a human.

### Specific Example of Procedure 3

FIG. 37 is an explanatory diagram illustrating a specific example of the procedure 3 illustrated in FIG. 34.

If another grasping mode is more appropriate than a grasping mode that has been determined first ((A) of FIG. 37), an action of changing the grasping mode may be performed ((B) of FIG. 37). In the robot system according to the embodiment, it is possible to quickly change the grasping mode by using recognition information about the measurement target such as the object 50 or an environment. It is to be noted that a trajectory along the object 50 may be taken around the tactile sensor measurement point Pt. An influence of an error is large around the distance measurement sensor measurement point Pr; therefore, the trajectory of the finger 11 may be controlled with a margin ((C) of FIG. 37).

(Modification Example of Technique of Determining Grasping mode)

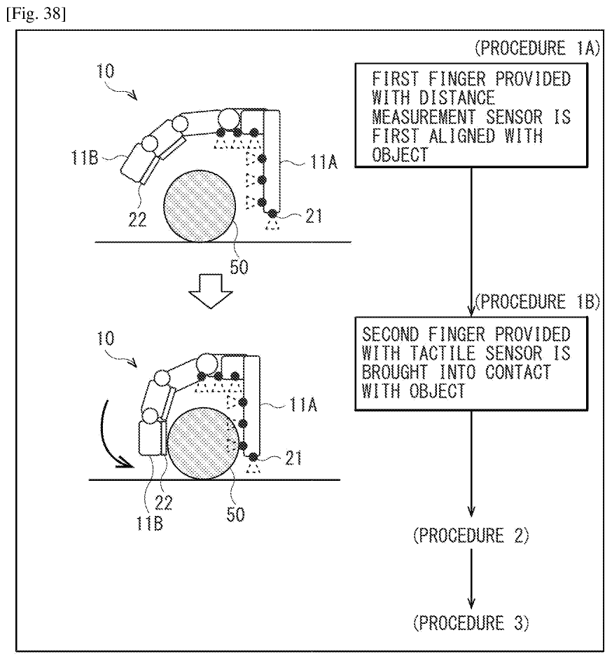

FIG. 38 is an explanatory diagram illustrating a modification example of the technique of determining a grasping mode with use of an object environment recognition result including uncertainty information in the robot system according to the embodiment.

In the hand 10 having a plurality of fingers 11, in many cases, it is difficult to mount the distance measurement sensor 21 and the tactile sensor 22 on the same finger 11 due to space limitations. For example, in a case where the plurality of fingers 11 includes a first finger 11A and a second finger 11B, types of sensors to be mounted may be separated for respective fingers. For example, only the distance measurement sensor 21 may be mounted on the first finger 11A and only the tactile sensor 22 may be mounted on the second finger 11B.

In this case, the first finger 11A provided with the distance measurement sensor 21 is first aligned with the object 50, and the distance measurement sensor 21 performs measurement (a procedure 1A). Thereafter, the second finger 11B provided with the tactile sensor 22 is brought into contact with the object 50 to perform measurement by the tactile sensor 22 (a procedure 1B). Thereafter, procedures from the procedure 2 in FIG. 34 may be executed.

### 1.6 Use of Sensor Other than Distance Measurement Sensor and Tactile Sensor

In the robot system according to the embodiment, any other kind of sensor may be used in addition to the distance measurement sensor 21 and the tactile sensor 22.

For example, in the humanoid robot 1, a RGB(-D) sensor, a LiDAR, or the like mounted on the head or a surrounding environment may be used. It is possible to perform object recognition or shape recognition with the RGB(-D) sensor, the LiDAR or the like and obtain prior information about the measurement target such as the object 50 or an environment. In addition, the shape or size of the standard object 50 may be assumed from an object recognition result as an estimated shape of the object 50. In addition, the generated estimated shape and an estimated shape generated by the distance measurement sensor 21 and the tactile sensor 22 on a fingertip may be integrated.

In addition, at least one of sensors such as a vibration sensor, a microphone, and an acceleration sensor mounted at or around a spot of contact with the measurement target such as the object 50 or an environment may be used. These sensors may be used in place of the tactile sensor 22 or as an aid to the tactile sensor 22. It is possible to detect vibration caused by contact with the measurement target with these sensors, which makes it possible to detect a contact timing accurately. In addition, even if contact occurs at a spot where the tactile sensor 22 is not mounted, detection is possible.

(Use Example of Sensor Other than Distance Measurement Sensor 21 and Tactile Sensor 22)

FIG. 39 schematically illustrates an example in which a sound sensor (a microphone) 23 is provided as a sensor other than the distance measurement sensor 21 and the tactile sensor 22 in the robot system according to the embodiment.
Sound and vibration

For example, as illustrated in FIG. 39, it is possible to accurately know a timing of contact with the measurement target by sensing a sound or vibration generated upon contact between the object 50 that is the measurement target and the finger 11 of the hand 10. The sound and vibration propagate through a link of the finger, which makes it possible to detect contact even if contact occurs at a place where the tactile sensor 22 and the distance measurement sensor 21 are not provided. It is possible to use the microphone 23, an acceleration sensor, a force sensor, or the like.
Temperature

For example, it is possible to detect contact with the measurement target such as the object 50 or an environment with a temperature sensor. Sensitivity is enhanced in a case where the temperature sensor is mounted on a portion that the measurement target is to directly contact. The temperature sensor may be disposed at a point apart from a contact point; however, in a case where the temperature sensor is applied to, for example, the finger 11 of the hand 10, transfer of heat propagating through a link of the hand 10 is detected, resulting in a decrease in sensitivity and responsivity.
Torque sensor and force sensor

In a case where the sensors are applied to, for example, the finger 11 of the hand 10, it is possible to detect contact with the measurement target such as the object 50 or an environment with the torque sensor mounted on a finger joint and the force sensor mounted on a wrist. In this case, it is possible to determine the contact from sudden change in torque upon the contact, and determine change in force from a threshold related to magnitude, speed, or acceleration of a force. In addition, it is possible to estimate contact with the measurement target from a relationship between the position of a fingertip and a force that are derived from an encoder for each axis. It is possible to detect an extremely small force, and it is therefore effective to improve sensitivity of contact detection. In addition, even if the measurement target contacts a region where no sensor is provided, it is possible to detect the contact with the measurement target accurately.
Object recognition

It is possible to photograph the measurement target such as the object 50 or an environment with an imaging device such as a RGB camera and estimate identity of the measurement target in advance by object recognition. For example, it is possible to interpolate shape information with use of such information (e.g., to store a typical shape and perform pattern matching with a recognition result). In addition, for example, in a case where the imaging device is applied to, for example, the finger 11 of the hand 10, it is possible to determine a grasping mode in advance in accordance with the recognition result and perform fine correction of the grasping mode with a sensor value of the distance measurement sensor 21 or the tactile sensor 22.

### 1.7 Configuration Example of Control Block (Robot Control Device)

### Configuration Example 1 of Control Block

FIG. 40 is a block diagram schematically illustrating a first configuration example of a control block (a robot control device) of the robot system according to the embodiment.

At least a block of respective control blocks in the robot system according to the embodiment may include, for example, a computer including one or a plurality of CPUs (Central Processing Units), one or a plurality of ROMs (Read Only Memories), and one or a plurality of RAMs (Random Access Memories). In this case, processing in each control block may be implemented by causing the one or plurality of CPUs to execute processing based on a program stored in the one or plurality of ROMs or RAMs. In addition, the processing in each control block may be implemented by causing the one or plurality of CPUs to execute processing based on a program supplied from outside through a wired or wireless network.

The robot system according to the embodiment includes an object-environment recognition section 110 and an operation controller 120 as control blocks.

The object-environment recognition section 110 includes an object-environment measurement section 100, a distance information processor 101, a contact information processor 102, and an environment-object shape/orientation estimation section 103.

The operation controller 120 includes an operation mode determination section 200, a trajectory calculator 201, a motion controller 202, and an actuator section 203.

The object-environment measurement section 100 includes various sensors including the distance measurement sensor 21 and the tactile sensor 22, and a sensor signal acquisition processor that processes sensor signals from the various sensors. The object-environment measurement section 100 processes the sensor signals from the various sensors, and outputs data such as an RGB image, a Depth image, a distance, a Point Cloud, Event data, a force, a pressure, vibration, acceleration, a slippage, a contact position, and a contact area.

The distance information processor 101 performs signal processing on the sensor signal from the distance measurement sensor 21. The distance information processor 101 is also able to estimate a 3D position of the measurement target such as the object 50 or an environment from a mounting position of the distance measurement sensor 21 and information about the position/orientation of the robot. A reference coordinate system may be a root coordinate system or a world coordinate system. The distance information processor 101 outputs data such as a Depth image, a distance, and a measurement point position.

The contact information processor 102 performs signal processing on the sensor signal from the tactile sensor 22. The contact information processor 102 determines the contact position with the measurement target such as the object 50 or an environment with use of a mounting position of the tactile sensor 22 and information about the position/orientation of the robot. A reference coordinate system may be a robot coordinate system or a world coordinate system. The contact information processor 102 outputs data such as a contact flag, a slippage, a contact position, and a contact area.

The environment-object shape/orientation estimation section 103 outputs data of information (such as a shape and a position/orientation) about the measurement target such as the object 50 or an environment in combination with distance information and contact information. In a case of achieving matching with the shape of the measurement target such as the object 50 or an environment that has been stored in advance, the environment-object shape/orientation estimation section 103 also stores data of that shape.

The operation mode determination section 200 calculates an operation mode and outputs data of the operation mode. In a case of object grasping, the operation mode determination section 200 calculates a grasping mode (such as a clasping grasp and a fingertip grasp) as an operation mode. In a case of an operation of pushing the measurement target such as the object 50 or an environment, the operation mode determination section 200 calculates a position to be pushed, a force direction, and the like. In a case where there is a predefined operation state, the operation mode determination section 200 also includes a storage section for the operation state.

The trajectory calculator 201 calculates a trajectory of an end effector or a joint of the robot on the basis of output data from the environment-object shape/orientation estimation section 103 and the operation mode determination section 200.

The motion controller 202 generates a control command value for an actuator. Examples of the control command value for the actuator include command values for a position of a joint angle, speed, acceleration, and a force.

The actuator section 203 operates the robot on the basis of the control command value from the motion controller 202. The actuator section 203 includes a movable section that operates the robot, and a control processing block of the movable section.

### Configuration Example 2 of Control Block

FIG. 41 is a block diagram schematically illustrating a second configuration example of the control block (the robot control device) of the robot system according to the embodiment.

The object-environment recognition section 110 may further include an additional measurement spot specification section 104 and an environment-object information storage section 105.

The operation controller 120 may include an operation mode determination section 300, an operation mode storage section 301, and a position/orientation correction section 302 in place of the operation mode determination section 200.

As a result of estimation by the environment-object shape/orientation estimation section 103, it is desired to measure a portion where uncertainty is large again; therefore, the additional measurement spot specification section 104 specifies the spot of the portion. The additional measurement spot specification section 104 outputs data of 2D or 3D information about the position/orientation of the measurement target such as the object 50 or the environment represented by a world coordinate system, a robot coordinate system, or the like. In a case where it is desired to operate a joint for measurement, the additional measurement spot specification section 104 calculates a joint movement amount.

The operation mode determination section 300 calculates an operation mode and outputs data of the operation mode. In a case of object grasping, the operation mode determination section 300 calculates a grasping mode (such as a clasping grasp and a fingertip grasp). In addition, the operation mode determination section 300 determines the position of a contact point in consideration of grasp stability.

The operation mode storage section 301 stores information such as the grasping mode.

The position/orientation correction section 302 outputs data such as a correction amount of the position/orientation of the robot and information about the position/orientation after correction.

The trajectory calculator 201 calculates the trajectory of the end effector or the joint of the robot on the basis of output data from the additional measurement spot specification section 104, the position/orientation correction section 302, the environment-object shape/orientation estimation section 103, and the operation mode determination section 200.

### 1.8 Control Operation Examples

### First Example of Control Operation

FIG. 42 is a flowchart illustrating a first example of a control operation of the robot system according to the embodiment.

FIG. 42 illustrates an operation example in a case where a trajectory of the robot that has been decided is not corrected. The recognition section of the robot system first performs measurement of the measurement target such as the object 50 or an environment with the distance measurement sensor 21 (step S101). Thereafter, the recognition section of the robot system performs processing on distance information about the measurement target measured by the distance measurement sensor 21 (step S102). Thereafter, the recognition section of the robot system estimates the shape and the position/orientation of the measurement target such as the object 50 or an environment (step S103). Thereafter, the controller of the robot system determines the operation mode of the robot (step S104). Thereafter, the controller of the robot system calculates the trajectory of the robot (step S105). Thereafter, the controller of the robot system calculates an actuator command (step S106).

Thereafter, the recognition section of the robot system determines whether or not the robot has contacted the measurement target, on the basis of the sensor signal from the tactile sensor 22 (step S107). In a case where the recognition section of the robot system determines that the robot has not contacted the measurement target (step S107; N), the robot system returns to processing in the step S106.

In a case where the recognition section of the robot system determines that the robot has contacted the measurement target (step S107; Y), the recognition section of the robot system then performs processing on contact information about the measurement target measured by the tactile sensor 22 (step S108). Thereafter, the recognition section of the robot system estimates the shape and the position/orientation of the measurement target such as the object 50 or an environment (step S109). Thereafter, the controller of the robot system determines the operation mode of the robot (step S110). Thereafter, the controller of the robot system calculates the trajectory of the robot (step S111). Thereafter, the controller of the robot system calculates an actuator command (step S112). Thereafter, the controller of the robot system determines whether or not the operation has been completed (step S113). In a case where the operation is determined as having been completed (step S113; Y), the controller of the robot system ends processing. In a case where the operation is determined as having not been completed (step S113; N), the controller of the robot system returns to processing in the step S112.

### Second Example of Control Operation

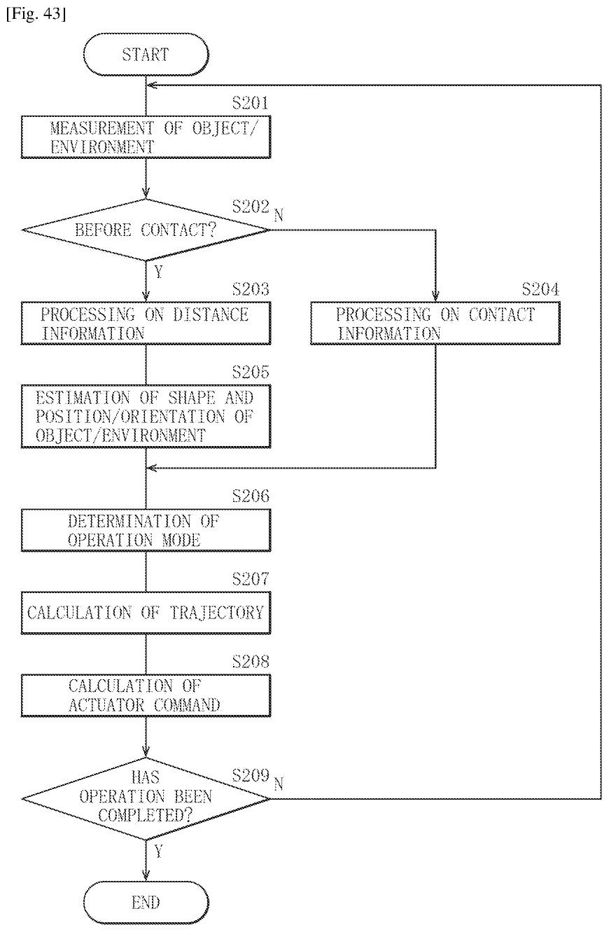

FIG. 43 is a flowchart illustrating a second example of the control operation of the robot system according to the embodiment.

FIG. 43 illustrates an operation example in which distance information and contact information are kept updated for each control period and the operation mode is calculated (corrected) for each control period. The recognition section of the robot system first measures the measurement target such as the object 50 or an environment with the distance measurement sensor 21 or the tactile sensor 22 (step S201). Thereafter, the recognition section of the robot system determines whether or not the robot has contacted the measurement target, on the basis of the sensor signal from the tactile sensor 22 (step S202).

In a case where the robot is determined as having contacted the measurement target (step S202; N), the recognition section of the robot system performs processing on the contact information about the measurement target measured by the tactile sensor 22 (step S204), and then proceeds to processing in step S206. In a case where the robot is determined as having not contacted the measurement target (step S202; Y), the recognition section of the robot system then performs processing on distance information about the measurement target measured by the distance measurement sensor 21 (step S203), and then proceeds to processing in step S205.

In the processing in the step S205, the recognition section of the robot system estimates the shape and the position/orientation of the measurement target such as the object 50 or an environment, and then proceeds to processing in step S206. In the processing in the step S206, the controller of the robot system determines the operation mode of the robot, and then proceeds to processing in step S207.

Thereafter, the controller of the robot system calculates the trajectory of the robot (step S207). Thereafter, the controller of the robot system calculates an actuator command (step S208). Thereafter, the controller of the robot system determines whether or not the operation has been completed (step S209). In a case where the operation is determined as having been completed (step S209; Y), the controller of the robot system ends processing. In a case where the operation is determined as having not been completed (step S209; N), the controller of the robot system returns to processing in the step S201.

### Third Example of Control Operation

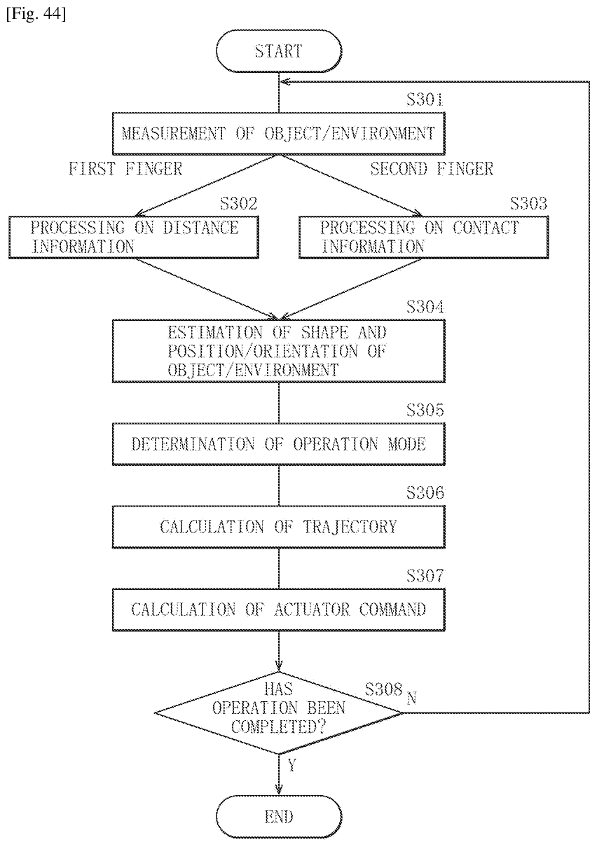

FIG. 44 is a flowchart illustrating a third example of the control operation of the robot system according to the embodiment.

The control operation in FIG. 44 is a control operation corresponding to the technique of determining a grasping mode illustrated in FIG. 38. In the technique of determining a grasping mode illustrated in FIG. 38, the robot is the hand 10 having the first finger 11A and the second finger 11B as the plurality of fingers 11, and the first finger 11A is provided with the distance measurement sensor 21 only, and the second finger 11B is provided with the tactile sensor 22 only.

The recognition section of the robot system measures the measurement target such as the object 50 or an environment with the distance measurement sensor 21 or the tactile sensor 22 (step S301). The recognition section of the robot system performs processing on distance information about the measurement target measured by the distance measurement sensor 21 provided on the first finger 11A (step S302) and processing on contact information about the measurement target measured by the tactile sensor 22 provided on the second finger 11B (step S303) in parallel.

Thereafter, the recognition section of the robot system estimates the shape and the position/orientation of the measurement target such as the object 50 or an environment (step S304). Thereafter, the controller of the robot system determines the operation mode of the robot (step S305). Thereafter, the controller of the robot system calculates the trajectory of the robot (step S306). Thereafter, the controller of the robot system calculates an actuator command (step S307). Thereafter, the controller of the robot system determines whether or not the operation has been completed (step S308). In a case where the operation is determined as having been completed (step S308; Y), the controller of the robot system ends processing. In a case where the operation is determined as having not been completed (step S308; N), the controller of the robot system returns to processing in the step S301.

### 1.9 Effects

As described above, according to the robot system according to the embodiment, the measurement target is recognized on the basis of distance information about the measurement target measured by the distance measurement sensor 21 provided on the robot and tactile information about the measurement target measured by the tactile sensor 22 provided on the robot, and operation control of the robot is performed on the basis of information about the recognized measurement target. This makes it possible to improve recognition accuracy of the object 50 or an environment, and perform a flexible and stable operation by the robot depending on a situation.

According to the robot system according to the embodiment, both the distance measurement sensor 21 and the tactile sensor 22 are used, and even if uncertainty arises, it is possible to estimate information about the shape and the position/orientation of the measurement target such as the object 50 or an environment. This makes it possible to improve robustness in recognition in an environment.

In addition, according to the robot system according to the embodiment, using the distance measurement sensor 21 and the tactile sensor 22 in stages makes it possible to gradually increase recognition accuracy while considering uncertainty. The recognition accuracy, and time and a processing load desired for sensing are in a trade-off relationship; therefore, it is possible to differently use sensors depending on requested accuracy. This makes it easy to perform switching between a case of operating fast with low accuracy and a case of increasing accuracy no matter how much time takes.

In addition, according to the robot system according to the embodiment, the robot system does not significantly depend on a sensor technique because of a technique of using the sensors having different properties in stages; therefore, a sensor other than the distance measurement sensor 21 and the tactile sensor 22 is easily introduced. In addition, according to the robot system according to the embodiment, it is possible to set a weight in accordance with a noise level and reliability of a sensor in recognition of the measurement target, which makes it possible to use sensors having different accuracies and properties by mixture.

In addition, according to the robot system according to the embodiment, the degree of freedom of the robot is used, which makes it possible to obtain a wide range of information with a small number of sensors. In addition, according to the robot system according to the embodiment, it is possible to predefine a basic shape and operation variations; therefore, the robot system is quickly adaptable also to a robot having a different motion constraint.

In addition, according to the robot system according to the embodiment, both information from the distance measurement sensor 21 and information from the tactile sensor 22 are considered; therefore, the distance measurement sensor 21 and the tactile sensor 22 may not be mounted at the same place. This makes it possible to reduce the size of the robot and effectively use a space.

In addition, according to the robot system according to the embodiment, both the distance measurement sensor 21 and the tactile sensor 22 are used, and even if uncertainty arises, interaction is stably taken with an environment or the object 50 (such as object grasping, and pushing a portion of an environment). In addition, according to the robot system according to the embodiment, both the distance measurement sensor 21 and the tactile sensor 22 are used to take interaction with an environment or the object 50 in accordance with uncertainty, which allows for a safe operation of the robot and a safe operation in an environment in which a human is present.

(Comparison with Related Art)

PTL 1 (International Publication No. WO2021/033509) describes a technology for estimating a position/orientation of a robot on the basis of environmental information obtained from a contactless sensor (such as a RGB(-D), a ToF, or a GPS), and information obtained from a contact sensor when the robot contacts an environment. In the technology described in PTL 1, the position/orientation of the object 50 with respect to world coordinates is a known premise, and it is possible to estimate the position/orientation of the robot only. The position/orientation of the object 50 is not determined, and it is difficult to estimate fine features such as a shape. In contrast, the robot system according to the embodiment is a technology that makes is possible to estimate the position/orientation and the shape of the object 50, rather than the position/orientation of the robot. In addition, in the robot system according to the embodiment, it is also possible to detect a feature of a finer shape of the object 50, and it is thus possible to obtain more accurate information about the object 50. In addition, it is possible to derive an appropriate grasping mode and an appropriate grasping position by combining generated object information and generated sensor information.

PTL 2 (Japanese Unexamined Patent Application Publication No. H11-28692) describes a technology for detecting a distance or contact between the object 50 and a finger and estimating the shape of the object 50 by a contact bar attached to a hand. In the technology described in PTL 2, a premise is that the contact bar directly contacts the object 50; therefore, there is a possibility that the object 50 is damaged. In addition, it is difficult to perform measurement, for example, by tracing an object surface, and it is difficult to perform, for example, adjustment of the position/orientation of the hand during grasping. In contrast, in the robot system according to the embodiment, using both the distance measurement sensor 21 and the tactile sensor 22 makes it possible to know the shape of the object 50 in a contactless manner or a contact manner. Therefore, it is also possible to search for the object surface in a contactless manner, or to know the shape by contacting the object 50 and tracing the surface thereof. In addition, switching of the grasping mode is also possible in a contactless manner.

PTL 3 (International Publication No. WO2022/030242) describes a technology for performing object grasping without colliding with an obstacle while adjusting relative positions of an object and a hand and relative positions of an obstacle present around the object and the hand from a distance measured by a distance measurement sensor mounted on a surface of a robot hand. In the technology described in PTL 3, an accurate position/orientation and an accurate shape of the object 50 are not obtainable in many cases due to a distance measurement error or a constraint of a distance measurement range. For example, the object 50 during contact is out of the distance measurement range, and it is difficult to detect the object 50 with the distance measurement sensor, and it is erroneously determined that no object 50 is present in spite of contacting the object 50. In contrast, in the robot system according to the embodiment, information is obtained in both phases before and after contact by using the distance measurement sensor 21 and the tactile sensor 22. It is also possible to consider contact information, which makes it possible to obtain more accurate object information. Thus, it is possible to implement a more stable grasping operation.

Advantages of using not only the distance measurement sensor 21 but also using both the distance measurement sensor 21 and the tactile sensor 22 are as follows.
Object detection accuracy is improved.

Using sensors that measure different physical quantities makes it possible to mutually compensate for measurement errors. In general, the error of the distance measurement sensor 21 is larger than the error of the tactile sensor 22.
Object recognition is possible also after contact.

It is difficult for the distance measurement sensor 21 to recognize an object after contact. Therefore, it is desired to store information before contact. However, it becomes difficult to deal with a case where the object 50 is displaced while being in contact.
Object detection time and memory efficiency are improved.

Using a result of object detection by distance measurement makes it possible to narrow down places where object recognition is to be performed in more detail. As a result, it is possible to increase object detection accuracy in two stages, improve the efficiency, and suppress use of a memory.

It is to be noted that the effects described herein are merely illustrative and nonlimiting, and other effects may be included. The same applies to effects of the following other embodiments.

### 2. OTHER EMBODIMENTS

The technology according to the present disclosure is not limited to description of the embodiment described above, and may be modified in a variety of ways.

For example, the present technology may have the following configurations. According to the present technology having the following configurations, a measurement target is recognized on the basis of distance information about the measurement target measured by a distance measurement sensor provided on a robot and tactile information about the measurement target measured by a tactile sensor provided on the robot, and operation control of the robot is performed on the basis of information about the recognized measurement target. This makes it possible to improve recognition accuracy of an object or an environment, and perform a flexible and stable operation by the robot depending on a situation.

(1)

A robot control device including:
a recognition section that recognizes a measurement target on the basis of distance information about the measurement target measured by a distance measurement sensor provided on a robot and tactile information about the measurement target measured by a tactile sensor provided on the robot; and
a controller that performs operation control of the robot on the basis of information about the measurement target recognized by the recognition section.
   (2)

The robot control device according to (1), in which the recognition section recognizes a shape, and a position/orientation of the measurement target.

(3)

The robot control device according to (1) or (2), in which the controller performs, as operation control of the robot, control of at least one of an operation mode of the robot or a position/orientation of the robot.

(4)

The robot control device according to any one of (1) to (3), in which
the robot is configured to grasp an object as the measurement target, and
the controller performs, as operation control of the robot, control of at least one of a grasping mode, a grasping position, or a grasping orientation of the measurement target by the robot.
   (5)

The robot control device according to any one of (1) to (4), in which
the robot is configured to allow at least a part thereof to be movable, and
the controller performs, as operation control of the robot, control of at least one of a moving speed or a trajectory of the at least the part of the robot.
   (6)

The robot control device according to any one of (1) to (5), in which the controller performs operation control of the robot on the basis of the distance information measured before contacting the measurement target, and thereafter corrects operation control of the robot on the basis of the tactile information measured after contacting the measurement target.

(7)

The robot control device according to any one of (1) to (6), in which
the robot is configured to allow at least a part thereof provided with the distance measurement sensor or the tactile sensor to be movable, and
the controller performs operation control of the at least the part provided with the distance measurement sensor or the tactile sensor to locate a measurement point of the distance measurement sensor or a measurement point of the tactile sensor at a spot where measurement of the measurement target by the distance measurement sensor or the tactile sensor is insufficient.
   (8)

The robot control device according to any one of (1) to (7), in which
the robot is configured to grasp an object as the measurement target, and
the controller performs operation control of the robot to determine a grasp point in consideration of grasp stability from among a plurality of grasp candidate points on the basis of information about the measurement target recognized by the recognition section and grasp the object as the measurement target at the determined grasp point.
   (9)

The robot control device according to any one of (1) to (8), in which, in the robot, the tactile sensor is provided on a portion having a high contact frequency with the measurement target, and the distance measurement sensor is provided on a portion having a low contact frequency with the measurement target.

(10)

The robot control device according to any one of (1) to (9), in which, in the robot, the tactile sensor and the distance measurement sensor are alternately provided.

(11)

The robot control device according to any one of (1) to (11), in which the robot has a protrusion part and a recess part, the tactile sensor is provided on the protrusion part, and the distance measurement sensor is provided on the recess part.

(12)

The robot control device according to (11), in which the protrusion part includes a flexible material that is to be deformed by contact with the measurement target.

(13)

The robot control device according to any one of (1) to (12), in which the recognition section estimates a shape between a measurement point by the distance measurement sensor and a measurement point by the tactile sensor in the measurement target through interpolation.

(14)

The robot control device according to any one of (1) to (13), in which the recognition section estimates a shape of the measurement target while weighting measurement points to increase weighting on a measurement point by the tactile sensor relative to a measurement point by the distance measurement sensor.

(15)

The robot control device according to any one of (1) to (14), in which the recognition section estimates a shape of the measurement target on the basis of a probability distribution of measurement points calculated on the basis of a measurement point by the distance measurement sensor and a measurement point by the tactile sensor.

(16)

The robot control device according to any one of (1) to (15), in which the recognition section estimates an entire shape of the measurement target on the basis of partial observation information about the measurement target by the distance measurement sensor and the tactile sensor.

(17)

The robot control device according to any one of (1) to (16), in which the recognition section estimates an entire shape of the measurement target by performing pattern matching between information about a plurality of template objects prepared in advance and partial observation information about the measurement target by the distance measurement sensor and the tactile sensor.

(18)

The robot control device according to any one of (1) to (16), in which the recognition section estimates an entire shape, and a position/orientation of the measurement target by performing pattern matching between prior information about the measurement target and partial observation information about the measurement target by the distance measurement sensor and the tactile sensor.

(19)

A robot control method including:
recognizing a measurement target on the basis of distance information about the measurement target measured by a distance measurement sensor provided on a robot and tactile information about the measurement target measured by a tactile sensor provided on the root; and
performing operation control of the robot on the basis of information about the recognized measurement target.
   (20)

A robot system including:
a robot provided with a distance measurement sensor and a tactile sensor; and
a robot control device that performs control of the robot,
the robot control device including
a recognition section that recognizes a measurement target on the basis of distance information about the measurement target measured by the distance measurement sensor provided on the robot and tactile information about the measurement target measured by the tactile sensor provided on the robot, and
a controller that performs operation control of the robot on the basis of information about the measurement target recognized by the recognition section.

It should be understood by those skilled in the art that various modifications, combinations, sub-combinations, and alterations may occur depending on design requirements and other factors insofar as they are within the scope of the appended claims or the equivalents thereof.

### REFERENCE SIGNS LIST

1 humanoid robot
2 body
3 arm
4 cart (wheel)
5 camera (head sensor)
10 hand (robot hand)
11 finger
11A finger (first finger)
11B finger (second finger)
21 distance measurement sensor
22 tactile sensor
23 sound sensor (microphone)
31 recess part
32 protrusion part
40 legged robot
41 leg
50 object (measurement target)
51 object (template object)
52 region (surrounded by a friction cone)
60 drone
100 object-environment measurement section (sensor, sensor signal acquisition processor)
101 distance information processor
102 contact information processor
103 environment-object shape/orientation estimation section
104 additional measurement spot specification section
105 environment-object information storage section
110 object-environment recognition section (recognition section)
120 operation controller (controller)
200 operation mode determination section
201 trajectory calculator
202 motion controller
203 actuator section
300 operation mode determination section
301 operation mode storage section
302 position/orientation correction section
Pt tactile sensor measurement point
Pr distance measurement sensor measurement point
Pa grasp candidate point
Pb contact point

1. A robot control device comprising:
a recognition section that recognizes a measurement target on a basis of distance information about the measurement target measured by a distance measurement sensor provided on a robot and tactile information about the measurement target measured by a tactile sensor provided on the robot; and
a controller that performs operation control of the robot on a basis of information about the measurement target recognized by the recognition section.

2. The robot control device according to claim 1, wherein the recognition section recognizes a shape, and a position/orientation of the measurement target.

3. The robot control device according to claim 1, wherein the controller performs, as operation control of the robot, control of at least one of an operation mode of the robot or a position/orientation of the robot.

4. The robot control device according to claim 1, wherein
the robot is configured to grasp an object as the measurement target, and
the controller performs, as operation control of the robot, control of at least one of a grasping mode, a grasping position, or a grasping orientation of the measurement target by the robot.

5. The robot control device according to claim 1, wherein
the robot is configured to allow at least a part thereof to be movable, and
the controller performs, as operation control of the robot, control of at least one of a moving speed or a trajectory of the at least the part of the robot.

6. The robot control device according to claim 1, wherein the controller performs operation control of the robot on a basis of the distance information measured before contacting the measurement target, and thereafter corrects operation control of the robot on a basis of the tactile information measured after contacting the measurement target.

7. The robot control device according to claim 1, wherein
the robot is configured to allow at least a part thereof provided with the distance measurement sensor or the tactile sensor to be movable, and the controller performs operation control of the at least the part provided with the distance measurement sensor or the tactile sensor to locate a measurement point of the distance measurement sensor or a measurement point of the tactile sensor at a spot where measurement of the measurement target by the distance measurement sensor or the tactile sensor is insufficient.

8. The robot control device according to claim 1, wherein
the robot is configured to grasp an object as the measurement target, and
the controller performs operation control of the robot to determine a grasp point in consideration of grasp stability from among a plurality of grasp candidate points on a basis of information about the measurement target recognized by the recognition section and grasp the object as the measurement target at the determined grasp point.

9. The robot control device according to claim 1, wherein, in the robot, the tactile sensor is provided on a portion having a high contact frequency with the measurement target, and the distance measurement sensor is provided on a portion having a low contact frequency with the measurement target.

10. The robot control device according to claim 1, wherein, in the robot, the tactile sensor and the distance measurement sensor are alternately provided.

11. The robot control device according to claim 1, wherein the robot has a protrusion part and a recess part, the tactile sensor is provided on the protrusion part, and the distance measurement sensor is provided on the recess part.

12. The robot control device according to claim 11, wherein the protrusion part includes a flexible material that is to be deformed by contact with the measurement target.

13. The robot control device according to claim 1, wherein the recognition section estimates a shape between a measurement point by the distance measurement sensor and a measurement point by the tactile sensor in the measurement target through interpolation.

14. The robot control device according to claim 1, wherein the recognition section estimates a shape of the measurement target while weighting measurement points to increase weighting on a measurement point by the tactile sensor relative to a measurement point by the distance measurement sensor.

15. The robot control device according to claim 1, wherein the recognition section estimates a shape of the measurement target on a basis of a probability distribution of measurement points calculated on a basis of a measurement point by the distance measurement sensor and a measurement point by the tactile sensor.

16. The robot control device according to claim 1, wherein the recognition section estimates an entire shape of the measurement target on a basis of partial observation information about the measurement target by the distance measurement sensor and the tactile sensor.

17. The robot control device according to claim 1, wherein the recognition section estimates an entire shape of the measurement target by performing pattern matching between information about a plurality of template objects prepared in advance and partial observation information about the measurement target by the distance measurement sensor and the tactile sensor.

18. The robot control device according to claim 1, wherein the recognition section estimates an entire shape, and a position/orientation of the measurement target by performing pattern matching between prior information about the measurement target and partial observation information about the measurement target by the distance measurement sensor and the tactile sensor.

19. A robot control method comprising:
recognizing a measurement target on a basis of distance information about the measurement target measured by a distance measurement sensor provided on a robot and tactile information about the measurement target measured by a tactile sensor provided on the root; and
performing operation control of the robot on a basis of information about the recognized measurement target.

20. A robot system comprising:
a robot provided with a distance measurement sensor and a tactile sensor; and
a robot control device that performs control of the robot,
the robot control device including
a recognition section that recognizes a measurement target on a basis of distance information about the measurement target measured by the distance measurement sensor provided on the robot and tactile information about the measurement target measured by the tactile sensor provided on the robot, and
a controller that performs operation control of the robot on a basis of information about the measurement target recognized by the recognition section.
